(19) United States
(12) Patent Application Publication
(10) Pub. No.: US 2025/0392168 A1
(43) Pub. Date: Dec. 25, 2025

(54) ENERGY HARVESTING, AUTOMATIC RECHARGING, AND POWER CONSUMPTION REDUCTION FOR SMART HOME SENSORS, DEVICES, AND NETWORKS

(71) Applicant: Roku, Inc., San Jose, CA (US)

(72) Inventors: Patrick Alan BROUILLETTE, Tempe, AZ (US); Robert Caston CURTIS, Los Gatos, CA (US); David Lee STERN, Los Gatos, CA (US); Sunil RAMESH, Saratoga, CA (US); Gregory Mack GARNER, Key Colony Beach, FL (US)

(73) Assignee: Roku, Inc., San Jose, CA (US)

(21) Appl. No.: 18/750,717

(22) Filed: Jun. 21, 2024

(51) Int. Cl. H02J 50/23; H02J 50/00; H02J 50/40; H02J 50/80; H02J 50/90

(52) U.S. Cl. CPC H02J 50/23; H02J 50/40; H02J 50/80; H02J 50/90; H02J 50/001

(57) ABSTRACT

Disclosed herein are system, apparatus, article of manufacture, method and/or computer program product embodiments, and/or combinations and sub-combinations thereof, for energy harvesting, automatic recharging, and power consumption reduction for smart home sensors, devices, and networks. An example embodiment operates by determining an estimated or predicted future time that a device will have insufficient electrical energy in an energy storage of the device for the device to operate. The device can be, for example, an internet-of-things device, such as a sensor, actuator, and/or RF communications repeater, that includes a radio frequency communication transmitter and an energy harvester. Based on and prior to the estimated or predicted future time, there is commanded an activation of a directed energy recharger in sufficient proximity to the device such that a directed energy beam transmitted or emitted by the directed energy recharger upon activation increases the energy stored in the energy storage of the device.

### BACKGROUND

### Field

This disclosure is generally directed to Internet-of-Things (IoT) home sensor networks, and more particularly to energy harvesting, automatic recharging, and power consumption reduction for smart home sensors, devices, and networks.

### SUMMARY

Provided herein are system, apparatus, article of manufacture, method and/or computer program product embodiments, and/or combinations and sub-combinations thereof, for energy harvesting, automatic recharging, and power consumption reduction for smart home sensors, devices, and networks.

An example embodiment for automated recharging of a radio-frequency (RF) communication-enabled device not coupled to an electrical power distribution system operates by a processor determining an estimated or predicted future time that a device will have insufficient electrical energy stored in an energy storage of the device for the device to operate. The device includes an RF communication transmitter and an energy harvester. The device is not coupled to an electrical power distribution system to receive power from the electrical power distribution system in a way capable of recharging the energy storage of the device. Based on and prior to the estimated or predicted future time, the processor commands an activation of a directed energy recharger in sufficient proximity to the device such that a directed energy beam transmitted or emitted by the directed energy recharger upon activation increases the energy stored in the energy storage of the device.

Another example embodiment is a system that includes one or more memories and at least one processor coupled to at least one of the memories. The at least one processor is configured to perform operations. The operations include determining an estimated or predicted future time that a device will have insufficient electrical energy stored in an energy storage of the device for the device to operate. The device comprises an RF communication transmitter and an energy harvester. The device is not coupled to an electrical power distribution system to receive power from the electrical power distribution system in a way capable of recharging the energy storage of the device. The operations further include, based on and prior to the estimated or predicted future time, commanding activation of a directed energy recharger in sufficient proximity to the device such that a directed energy beam transmitted or emitted by the directed energy recharger upon activation increases the energy stored in the energy storage of the device.

Another example embodiment is a non-transitory computer-readable medium having instructions stored thereon that, when executed by at least one computing device, cause the at least one computing device to perform operations. The operations include determining an estimated or predicted future time that a device will have insufficient electrical energy stored in an energy storage of the device for the device to operate. The device comprises an RF communication transmitter and an energy harvester. The device is not coupled to an electrical power distribution system to receive power from the electrical power distribution system in a way capable of recharging the energy storage of the device. The operations further include, based on and prior to the estimated or predicted future time, commanding activation of a directed energy recharger in sufficient proximity to the device such that a directed energy beam transmitted or emitted by the directed energy recharger upon activation increases the energy stored in the energy storage of the device.

### BRIEF DESCRIPTION OF THE FIGURES

The accompanying drawings are incorporated herein and form a part of the specification.

FIG. 1 is a block diagram of a multimedia/IoT environment, according to some embodiments.

FIG. 2 is a block diagram of a media device/IoT controller, according to some embodiments.

FIG. 3 is a block diagram of an IoT device, according to some embodiments.

FIG. 4 is a flow diagram illustrating an example feedback method of directed RF energy transmission between an IoT device equipped with a directed-energy transmitter and an energy-harvesting IoT device equipped to receive and transduce the RF energy to electrical energy.

FIG. 5A is a perspective view of an example IoT light switch configured to harvest energy from the switching action of a user.

FIGS. 5B and 5C are side-view diagrams illustrating an example linear energy-harvesting functioning of an embodiment of the IoT light switch of FIG. 5A.

FIGS. 5D and 5E are side-view diagrams illustrating an example rotational energy-harvesting functioning of another embodiment of the IoT light switch of FIG. 5A

FIGS. 6A and 6B are perspective views of an example IoT door or window sensor switch configured to harvest energy from the opening and closing of the associated door or window.

FIG. 7 is a perspective view of another IoT door or window sensor configured to harvest energy from the opening and closing of the associated door or window.

FIG. 8A is a perspective view of an example IoT AC power outlet panel configured with an RF energy transmitter.

FIG. 8B is a side view of the IoT AC power outlet panel of FIG. 8A.

FIG. 8C is a perspective view of an example IoT AC power outlet panel configured with an optical energy transmitter.

FIG. 8D is a side view of the IoT AC power outlet panel of FIG. 8C.

FIG. 9A is a perspective view of an example room including a light fixture globe as a decorative element configured with an energy transmitter to charge multiple energy-harvesting IoT devices in the room.

FIG. 9B is a perspective view of an example room including a mirrored ball as a decorative element configured with an energy transmitter to charge multiple energy-harvesting IoT devices in the room.

FIG. 10A is a perspective view of an example robotic vacuum cleaner configured with an optical energy transmitter.

FIG. 10B is a perspective view of the example robotic vacuum cleaner of FIG. 10A further configured with a scissors mechanism to elevate the optical energy transmitter.

FIG. 10C is a perspective view of the example robotic vacuum cleaner of FIG. 10A further configured with a telescoping mechanism to elevate the optical energy transmitter.

FIGS. 11A and 11B are perspective views of an example robotic flying drone configured with an energy transmitter to recharge an energy-harvesting IoT device.

FIG. 12A is a perspective view of a user alert displayed on a television display of a media/IoT system.

FIG. 12B is a perspective view of a user alert displayed on a mobile device associated with a media/IoT system.

FIG. 12C is a perspective view of a remote control of a media/IoT system configured with an energy transmitted to recharge an energy-harvesting IoT device.

FIG. 13A is a perspective view of mobile device associated with a media/IoT system and configured to acquire spatial awareness data via a photograph of an IoT environment layout.

FIG. 13B is a perspective view of a mobile device configured to display a IoT device placement advice including a pictorial representation of a suggested IoT device placement location based on the acquired spatial awareness data of FIG. 13A.

FIG. 14 is a flow diagram illustrating an example computer-implemented method of automated recharging of IoT devices.

FIG. 15 is a block diagram illustrating an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for energy harvesting, automatic recharging, and power consumption reduction for smart home sensors, devices, and networks.

Networks of sensors, controls, repeaters, energy chargers, and other devices (“IoT devices”) can offer safety, security, and convenience features in home and commercial settings. In a smart home context, for example, IoT devices can be related to home or yard lighting management, electrical household appliance management, home temperature management (e.g., heating/cooling), secure physical access management (e.g., managing door locks and automatic doors, such as garage doors), media playback management (e.g., audio, video), disaster sensing (e.g., smoke, CO₂, flood, fire) and management (e.g., via a fire suppression system, such as may use water or foam to quench flames), household cleaning and/or maintenance management, household status monitoring (e.g., doors left open, oven or range left on), pet or houseplant monitoring, remote pet or houseplant care (e.g., feeding, watering), and numerous other applications. Similar or other functions can be performed by IoT systems in commercial settings, such as offices, retail stores, warehouses, manufacturing plants, and industrial yards. Although the examples of this description may be generally with reference to smart home contexts, the systems, devices, and methods described herein are generally applicable to both home and business settings, and are not limited to use in smart homes.

The IoT devices that can provide these and other features can be networked to each other, to one or more central controllers, and/or to the internet (e.g., the cloud) using various signal transmission modalities and various protocols. Such networking can be wired or wireless, and can be via electrical conduction, radio-frequency (RF) transmission, microwave transmission, and optical transmission, as examples.

The one or more central controllers and/or remote controllers residing on the internet or the cloud can process inputs from the IoT devices to control these or other IoT devices and/or to provide alerts or other information to one or more users. As one example, an IoT controller can detect that an oven has been left on and send a text message, e-mail message, or alert notification to a mobile device (e.g., cellular phone) or other computing device (e.g., desktop personal computer) of a user. The transmission of the message can, for example, be further based on the amount of time the over has been left on, a detection that no one is home (e.g., via other IoT sensors, such as motion sensors and/or door sensors), and/or an awareness of the user's geographical location as being away from home, such as may be derived from a location sensor (e.g., GPS) in a mobile device (e.g., smartphone) of the user. Upon receiving the message, if the oven is an IoT oven, the user may remotely command an adjustment to the oven (e.g., turning it down or off) via the user's mobile device or other computing device and the IoT controller. Alternatively, the IoT controller may determine (e.g., based on a ruleset or neural network output) that the IoT oven has been left on in error and automatically command its deactivation, without user intervention.

As another example, an IoT controller can detect, via a signal from an IoT pet feeder, that a bowl of the pet feeder is empty and that the current time equals or exceeds a pre-set pet mealtime, and thus may either so notify a user and/or may automatically command the dispensing of pet food from the feeder. As another example, an IoT controller can detect, via a signal from an IoT smoke detector or IoT thermal sensor, that an unwanted fire has started, and thus may either so notify a user and/or a fire department and/or may automatically command activation of a fire suppression system (e.g., a sprinkler system or fire extinguisher). As yet another example, an IoT controller can detect, via a signal from an IoT door sensor, that a door has been inadvertently left open or unlocked, and thus may either so notify a user and/or may automatically command the locking or closure of the door, according to the abilities of the door.

As still other examples, the IoT controller can provide to the user, via the user's mobile device or other computing device, real-time or historical views or displays of IoT data, such as real-time or historical views of video data from IoT security video cameras, so that a user can check for intruders, guests, or pets, for example, or real-time or historical graphs of home temperature derived from one or more IoT temperature sensors. As still other examples, the IoT controller can process historical data and/or user responses to alert notifications and/or other user inputs to generate schedules of IoT device activation, deactivation, or adjustment, such as may manage home temperature with improved energy efficiency, or such as may manage entertainment devices in accordance with prescribed wake times, work times, and/or bedtimes, as just a few examples.

As examples, user inputs to an IoT controller may take the form of commands, lists, schedules, or broadly stated desires, which can be interpreted by the IoT controller to form command functions of the IoT system. As examples, user inputs to an IoT controller may be formatted in accordance with a defined data format or protocol, or may take the form of natural-language sentences or paragraphs. As examples, user inputs to the IoT controller may be in the form of inputs to a menu system or other graphical user interface, written or typed text, drawn pictorial symbols, or spoken language. As examples, the user inputs can be processed by one or more large language models (LLMs) or one or more other machine-learning (ML) models or one or more other neural network-based command interpreters. Command functions of the IoT system can include activating, deactivating, or calibrating sensors of the IoT system, activating, deactivating, or calibrating actuators of the IoT system, setting particular schedules for sensor or actuator activation, deactivation, or calibration, requesting (either in real-time or at a later scheduled time) reports of raw or processed data generated by the IoT system, and/or inputting other user data or system data into the IoT system. Examples of user data can include one or more names, addresses, phone numbers, and e-mail addresses. Examples of system data can include information about IoT devices in the system, such as relative or absolute device locations or sensor or actuator calibration values.

Thus communicatively enabled, IoT devices may be placed throughout a home or business premises to perform the sensing, actuation, and other functions useful for monitoring and device administration of the home or business premises. Some IoT devices may be installed into the electrical power distribution system of the home or business premises, for example, by being plugged into an AC power outlet or being directly wired into the AC mains of the home or business premises. For other IoT devices, it may not be convenient or practicable to provide them with a reliable, substantially permanent source of electrical power. As examples, a desired location of an IoT device may not be near enough an AC power outlet to be plugged or wired in, the IoT device may be mobile or portable and thus not amenable to being plugged or wired in, or the IoT device may be placed, oriented, sized, or dimensioned in a way that renders impracticable being plugged or wired in to a sustained power source. As an example, a video camera or motion sensor may be placed under the eaves of a roof of a house, in a tree, or on a high pole near but outside a home, with no access to an electrical power connection.

Such IoT devices may be equipped with replaceable batteries, such as alkaline batteries, and use battery power, with the disadvantages of the inconvenience to the user of regular battery monitoring and replacement or recharging, and the detriments to the system of having inactive IoT devices for any durations during which the batteries are exhausted and need replacement or recharging. Removal of a battery from an IoT device, or removal of the IoT device from its proper location, for recharging can effectively eliminate the IoT device from the larger IoT environment for a time, with potential detrimental consequences. A user may also fail to replace or recharge batteries for extended periods, resulting in an IoT system of diminished capability and usefulness. As an example, unpowered and thus disabled IoT smoke detectors or intrusion detectors may leave a premises vulnerable to catastrophe such as invasion, theft, or fire. The need for human vigilance and effort in maintaining a powered IoT device suite can substantially add to the ongoing cost of the IoT system. Moreover, replacing exhausted non-rechargeable batteries or defective rechargeable batteries can pose negative environmental externalities from the additional solid waste and pollution associated with disposed-of batteries.

It is accordingly an objective of the systems, devices, methods, and computer-readable media described herein to provide for robust, reliable, reduced-maintenance IoT systems by using IoT devices and networks of such devices that are configured for energy harvesting, automatic recharging, and reduced power consumption reduction. It is further an objective of the systems, devices, methods, and computer-readable media described herein to reduce solid waste, pollution, and human attention requirements associated with IoT system maintenance. It is further an objective of the systems, devices, methods, and computer-readable media described herein to integrate IoT control systems with home media systems to enhance readiness of adoption, ease of use, and standardization of components and setup procedures.

As examples, embodiments as described herein can provide robust support for rechargeable-battery-powered or batteryless sensors, actuators, and other IoT devices that harvest their energy from the environment and/or are easily recharged in an automated manner, or with reduced manual effort as compared to systems having conventional battery-powered IoT devices. For example, such support can be provided using automated recharging of unpowered sensors and devices via stationary points and mobile robots, such as roving floor robots, flying drones, mounted directable lasers, and mounted directable RF beam chargers. In some examples, automated charging devices are integrated as decorative or utilitarian elements of home design, such as furniture, light fixtures, lighting receptacles, light switches, power outlet receptacles, light reflectors, or disco balls. As a further example, support for rechargeable-battery-powered or batteryless sensors, actuators, and other IoT devices can be provided using a smart home network application (e.g., for a mobile device such as a smartphone) that can aid in placement of IoT devices, including IoT devices acting as signal repeaters, during setup, that can aid in subsequent energy direction, and an overall spatial awareness and network power status understanding of an IoT system to enable reactive, preemptive, or predictive recharging of IoT devices.

As other examples, embodiments as described herein can provide manual recharge methods, including by using a TV remote control capable of recharging sensors that may be otherwise unpowered. As other examples, embodiments as described herein can provide single-use wireless sensors, such as fire or flood detectors, powered only by energy inherent in or derived from their triggering events. As other examples, embodiments as described herein can provide circuitry or transmission protocols that reduce IoT device power consumption.

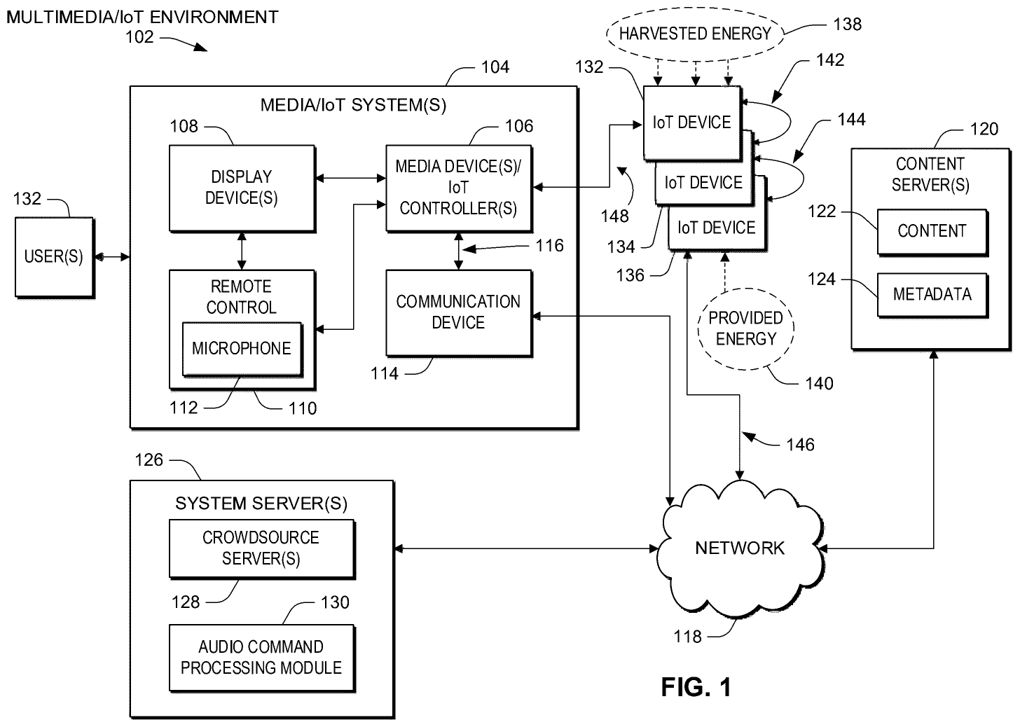

Various embodiments of this description may be implemented using and/or may be part of a multimedia/IoT environment 102 shown in FIG. 1. Multimedia/IoT environment 102 is provided for illustrative purposes and is not limiting. Embodiments of this disclosure may be implemented using and/or may be part of environments different from and/or in addition to the multimedia/IoT environment 102.

### Multimedia/IoT Environment

The block diagram of FIG. 1 illustrates an example multimedia/IoT environment 102. In some examples, multimedia/IoT environment 102 is directed in part to streaming media. In other example, multimedia/IoT environment 102 can be directed in part to other types of media instead of or in addition to streaming media, as well as any mechanism, means, protocol, method and/or process for distributing media.

The multimedia/IoT environment 102 may include one or more media/IoT systems 104. A media/IoT system 104 can represent a home, office, a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play media content, such as streaming content, and/or to use and administer an IoT system to provide monitoring and control functions to IoT devices. One or more user 132 may operate the media/IoT system 104 to select and consume content and/or to setup, maintain, observe, and control IoT devices.

Each media/IoT system 104 may include one or more media devices/IoT controllers 106, each coupled to one or more display devices 108. Terms such as “coupled,” “connected to,” “attached,” “linked,” “combined,” and similar terms may refer to physical, electrical, magnetic, or logical connections, unless otherwise specified herein. One or more of the media devices/IoT controllers 106 may serve as a device for selecting and playing media, such as streaming media. One or more of the media devices/IoT controllers 106 may alternatively or additionally serve as an IoT controller to perform IoT system functions. The IoT system functions can include receiving and processing signals from one or more IoT devices (e.g., IoT devices 132, 134, 136), configuring the one or more IoT devices, tracking power charge or charging statuses of the one or more IoT devices, negotiating or scheduling automatic recharging of the one or more IoT devices, compiling and delivering reports to the one or more users 132 regarding the status or health of the IoT devices, delivering alert notifications (e.g., by text message, e-mail message, phone call, or software application notification) to the one or more users 132 based on defined IoT device status or detection, and other functions, as described herein.

Each of the one or more media devices/IoT controllers 106 may be a streaming media device, a DVD or BLU-RAY device, audio/video playback device, a cable box, and/or digital video recording device, as examples. Display device 108 may be a monitor, television (TV), computer, smartphone, tablet, wearable (such as a watch or glasses), appliance, IoT device, and/or projector, as examples. In some embodiments, a media device/IoT controller 106 can be a part of, integrated with, operatively coupled to, and/or connected to its respective display device 108, as in a smart TV, for example, which combines at least a display and streaming media device. Each of the one or more media devices/IoT controllers 106 may include one or more computer processors capable of carrying out both media functions and IoT functions. For example, a computer processor of a smart TV or a digital media box connected to a TV, ordinarily devoted to performing video and audio display functions, may additionally be configured to carry out IoT system functions as described herein. In this way, the smart TV or digital media box serves as a dual appliance and eliminates the necessity to have a separate appliance, apart from the smart TV, for carrying out IoT system functions, while also providing a convenience of user interface to IT system functions via an already-available display 108.

Each media device/IoT controller 106 may be configured to communicate with a network 118 via a communication device 114. The communication device 114 may include, as examples, a cable modem, a cellular modem, a direct subscriber line (DSL) modem, a fiber optic modem, and/or a satellite TV transceiver. The media device/IoT controller 106 may communicate with the communication device 114 over a link 116, wherein the link 116 may include wireless (such as Wi-Fi) and/or wired connections. In some embodiments, communication device 114 can be integrated with the media device/IoT controller 106 and/or the display device 108, as in a smart TV, for example, which combines a Wi-Fi transceiver or other network modem with its display and streaming media device.

In various embodiments, the network 118 can include, without limitation, wired and/or wireless intranet, extranet, the internet, cellular, Bluetooth, infrared, and/or any other short range, long range, local, regional, global communications mechanism, means, approach, protocol and/or network, as well as any combination(s) thereof.

Media/IoT system 104 may include a remote control 110. The remote control 110 can be any component, part, apparatus and/or method for controlling the media device/IoT controller 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device/IoT controller 106 and/or display device 108 using optical communication (e.g., infrared), RF communication (e.g., Bluetooth or cellular), or any combination thereof. The remote control 110 may include a microphone 112.

The multimedia/IoT environment 102 may include a plurality of content servers 120 (also called content providers, channels or sources 120). Although only one content server 120 is shown in FIG. 1, in practice the multimedia/IoT environment 102 may include any number of content servers 120. Each content server 120 may be configured to communicate with network 118. The one or more content servers 120 may be located remote from the media/IoT system 104. As an example, the media/IoT system 104 may be located in a home or business premises, whereas the one or more content servers 120 may be centrally or distributively located many miles (e.g., hundreds or thousands of miles) distant from the home or business premises. The one or more content servers 120 may serve a plurality (e.g., thousands or tens or hundreds of thousands, or millions) of different media/IoT systems 104 located in different homes and/or business premises across a region, nation, or the world.

The one or more content servers 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

In some embodiments, the one or more content servers 120 may store content 122 derived from IoT devices (e.g., IoT devices 132, 134, 136). As one example, IoT device 132 can be a video camera used as a security camera, and video data acquired by the security camera can be streamed or uploaded via the network 118 to be stored as content 122 in one or more content servers 120 for cloud storage and subsequent retrieval and viewing by a user 132, e.g., via a display device 108. As another example, IoT device 134 can be a temperature sensor, and temperature data acquired by the temperature sensor can be streamed or uploaded via the network 118 to one or more content servers 120 for cloud storage and processing. The temperature data can be aggregated with temperature data provided by other media/IoT systems 104 (e.g., of different homes) to analyze regional, national, or global trends that can affect energy usage.

In some examples, data derived from one IoT device or one subset of IoT devices can be stored as metadata 124 associated with data, stored as content 122, derived from another IoT device or another subset of IoT devices from the same media/IoT system 104. As an example extending from the above two examples, temperature data derived from a temperature-sensor IoT device 134 can be stored as metadata 124 associated with video data, stored as content 122, derived from a video-camera IoT device 132. Upon playback of the video data to the display device 108, the video data can be overlain with a display of the time-synchronized temperature data. In this way, outputs or statuses of various IoT devices can be mixed and overlain with other outputs of other IoT devices (such as video data) to provide more usefully informative enhanced video data.

In some examples, some or all of the IoT device-derived data stored in the one or more content servers 120 is encrypted, stored on the one or more content servers 120 in an encrypted state, and is decryptable only by the media/IoT system 104 that originated the data, helping to preserve privacy of sensitive home data, such as security video data. In some examples, some or all of the IoT device-derived data stored in the one or more content servers 120 is anonymized, e.g., by stripping the IoT data of identifying information that could be used to link the IoT data with the particular one or more media/IoT systems 104 that generated it, thus permitting for aggregated data analysis without substantially sacrificing IoT system user data privacy.

The multimedia/IoT environment 102 may include one or more system servers 126. The system servers 126 may operate to support the media devices/IoT controllers 106 and/or the IoT devices (e.g., IoT devices 132, 134, 136) from the cloud. The structural and functional aspects of the system servers 126 may wholly or partially exist in the same or different ones of the system servers 126. As with the one or more content servers 120, the one or more system servers 126 may be located remote from the media/IoT system 104. As an example, the media/IoT system 104 may be located in a home or business premises, whereas the one or more system servers 126 may be centrally or distributively located many miles (e.g., hundreds or thousands of miles) distant from the home or business premises. The one or more system servers 126 may serve a plurality (e.g., thousands or tens or hundreds of thousands, or millions) of different media/IoT systems 104 located in different home or business premises across a region, nation, or the world.

The media devices/IoT controllers 106 may exist in thousands or millions of media/IoT systems 104. Accordingly, the media devices 106 may lend themselves to crowdsourcing embodiments and, thus, the system servers 126 may include one or more crowdsource servers 128. For example, using information received from the media devices/IoT controllers 106 in the thousands and millions of media/IoT systems 104, the crowdsource server(s) 128 may identify similarities and overlaps between closed captioning requests issued by different users 132 watching a particular movie or TV show. Based on such information, the crowdsource server(s) 128 may determine that turning closed captioning on may enhance users' viewing experience at particular portions of the movie or TV show (for example, when the soundtrack of the movie or TV show is difficult to hear), and turning closed captioning off may enhance users' viewing experience at other portions of the movie or TV show (for example, when displaying closed captioning obstructs critical visual aspects of the movie or TV show). Accordingly, the crowdsource server(s) 128 may operate to cause closed captioning to be automatically turned on and/or off during future streamings of the movie or TV show.

The system servers 126 may also include an audio command processing module 130. As noted above, the remote control 110 may include a microphone 112. The microphone 112 may receive audio data from users 132 and/or from other sources, such as the display device 108. In some embodiments, the media device/IoT controller 106 may be audio responsive, and the audio data may represent verbal commands from the user 132 to control the media device/IoT controller 106 as well as other components in the media/IoT system 104, such as the display device 108. In some embodiments, the audio data received by the microphone 112 in the remote control 110 is transferred to the media device/IoT controller 106, which is then forwarded to the audio command processing module 130 in the system servers 126 via the network 118. The audio command processing module 130 may operate to process and analyze the received audio data to recognize a verbal command of the user 132. The audio command processing module 130 may then forward the recognized verbal command back to the media device/IoT controller 106 for execution of the command.

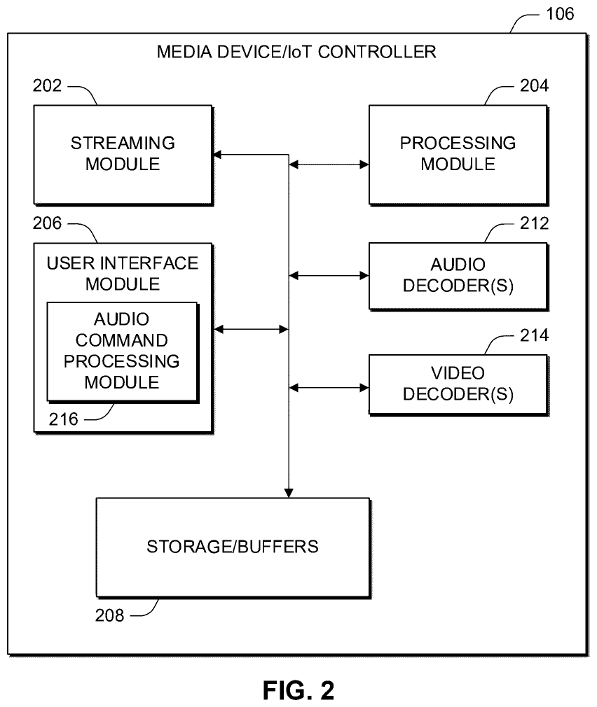

In some embodiments, the audio data may be alternatively or additionally processed and analyzed by an audio command processing module 216 in the media device/IoT controller 106 (see FIG. 2). The media device/IoT controller 106 and the system servers 126 may then cooperate to pick one of the verbal commands to process (either the verbal command recognized by the audio command processing module 130 in the system servers 126, or the verbal command recognized by the audio command processing module 216 in the media device/IoT controller 106).

The multimedia/IoT environment 102 may include one or more IoT devices. FIG. 1 illustrates three IoT devices 132, 134, 136, as an example, but in practice, the number of IoT devices associated with any given media/IoT system 104 may be fewer or more, e.g., in the tens, hundreds, or thousands. IoT devices in the multimedia/IoT environment 102 may also be accessible by multiple media/IoT systems 104 to provide their generated data and/or receive commands from any of the multiple media/IoT systems 104. The IoT devices may be communicatively coupled to the one or more media devices/IoT controllers 106 of the media/IoT system 104 in a variety of ways. As one example, illustrated by the connection 146 between IoT device 136 and network 118, the IoT device 136 may be coupled the media device/IoT controller 106, wired or wirelessly, via the network 118, communication device 114, and connection 116, without requiring the IoT device 136 to be directly coupled to the media device/IoT controller 106. As another example, illustrated by the connection 148 between media device/IoT controller 106 and IoT device 132, the IoT device 132 may be coupled directly to the media device/IoT controller 106, wired or wirelessly, without requiring communications through network 118.

As yet another example, illustrated by the connection 144 between IoT device 134 and IoT device 136, the IoT device 134 may be coupled to the media device/IoT controller 106, wired or wirelessly, or in some combination thereof, via IoT device 134, connection 146, network 118, communication device 114, and connection 116, without requiring either a direct connection to media device/IoT controller 106 or a direct connection to network 118. Such an example may be the case where IoT device 134 is expected to operate wirelessly with very low power expenditure, and thus may be configured to produce weak RF transmission signals that are only sufficiently strong enough to reliably reach a next nearest IoT device. The next nearest IoT device, IoT device 136 in the illustrated example, thus functions as a signal repeater, retransmitting the signal received from weakly transmitting IoT device 134, and sending it on through the network 118 and on to the media/IoT system 104.

One repeater hop 114 is illustrated between weakly transmitting IoT device 134 and network-connected IoT device 118, but in practice there may be a larger number of repeater hops. For example, if IoT device 132 is not directly connected to the media/IoT system 104 via connection 148, as illustrated, and is configured as a weakly transmitting device, then IoT device 132 can transmit to next-nearest IoT device 134 via connection 142, IoT device 134 can retransmit the received signal via connection 144 to IoT device 136, and IoT device 136 can retransmit the received signal originating from IoT device 132 on to the media/IoT system 104 via the network 118. Similarly, weakly transmitting IoT device 134 can successfully transmit to media/IoT system 104 via connection 142 to IoT device 132, which can retransmit the signal on to media device/IoT controller 106 via direct connection 116, or IoT device 136 can route signals in two hops to media/IT system 104 via connections 144 and 142 even absent connection to network 118. In this way, IoT devices can act as repeaters to retransmit weakly transmitted signals throughout a premises that has been equipped with IoT devices, thus lowering the power consumption requirements of IoT devices in the event that such devices are not reliably coupled to a sustained power source, such as AC mains.

IoT devices (e.g., IoT devices 132, 134, 136) can take a variety of forms and serve a variety of functions. In some example IoT devices, the IoT device is configured for bidirectional communication, and can thus both receive commands and also transmit signals, such as sensor signals, signals used for locating the IoT device, or command feedback signals. In other example IoT devices, the IoT device is configured only for unidirectional communication, either to receive or transmit signals but not both. IoT devices can be stationary (e.g., mounted to or installed in or on a wall, door, window, appliance, fixture, or furniture piece) or mobile (to be portable by a user 132 or other device, or equipped with self-locomotory apparatus such as powered wheels, treads, whegs, or propellers). In examples where an IoT device is self-locomotory, it can be provided with a docking station or “home base” to which it can be programmed to intermittently return for recharging and/or data transfer, either through conductive or wireless connections.

As examples, IoT devices (e.g., IoT devices 132, 134, 136) can be configured as device controls, appliances, access controls, sensors, network devices, charging devices, and output devices (e.g., displays or loudspeakers). As examples, IoT devices can integrate one or more of the following devices.

IoT devices can be configured as device controls, including a light switch or other appliance switch, a light dial or other appliance dial, a light fader or other appliance fader, an indoor temperature control (e.g., a thermostat), a door or window access control (e.g., a garage door opener button or home entry keypad), or a window treatment control (e.g., for adjusting window shades or blinds, or the opacity of self-tinting glass). Such controls may be configured to operate by conventional manual control, through remote commands received through a wired or wireless transmission protocol, and/or by voice commands, as examples.

IoT devices can be configured as appliances, including a refrigerator, an oven, a stove, a cooktop or range, a microwave oven, a dishwasher, a clothes washer, a clothes dryer, a television set, a toaster, a waffle iron, a coffee maker, a grinder, a boiler, a hot water heater, a water softener, an in-sink garbage disposal, a trash or recycling cart, a furnace, a lighting receptacle, an AC power outlet receptacle, a DC power jack receptacle (e.g., including a USB jack), an air conditioning condenser unit, a doorbell (e.g., a video doorbell), an irrigation system, a plant watering system, a pet feeder, a vacuum cleaner (e.g., a robot vacuum), a flying drone, an item of furniture (e.g., a bed, a recliner, a couch, a massage chair, a virtual reality table), an electric vehicle charger, a faucet, or a brewery system. Such IoT appliances may likewise be configured to operate by manual control, through remote commands received through a wired or wireless transmission protocol, and/or by voice commands, as examples.

IoT devices can be configured as access controls, including mechanical door or window locks, magnetic door or window locks, automatic door or window openers (e.g., garage door openers), drawer, cabinet, or safe locks, or merchandise security tags. Such IoT access controls may likewise be configured to operate by manual control, through remote commands received through a wired or wireless transmission protocol, and/or by voice commands, as examples.

IoT devices can be configured as sensors, including a video camera, a microphone, a baby monitor, an indoor or outdoor temperature sensor, a smoke detector, a carbon monoxide detector, a volatile organic compound sensor, a carbon dioxide sensor, a particulate matter sensor, a flood detector, a water line break detector, an acoustic window break sensor, a motion sensor, an active infrared thermal sensor, a door or window open sensor, an optical beam sensor (e.g., triggerable by beam interruptions), an outdoor wind sensor (e.g., an anemometer), a swimming pool temperature monitor, a swimming pool water quality monitor, a home health monitor (e.g., a bathroom scale, a blood pressure monitor, a blood glucose monitor, a pulse oximeter, a continuous positive airway pressure monitor, an electrocardiogramactivity tracker (e.g., for a human or a pet). IoT sensors can be configured to provide streaming or periodically updating sensor data, and/or can be configured to provide a signal upon a triggering event. As one example, an IoT video camera can acquire and transmit a continuous video stream, or can stream video for remote recording only upon detecting significant movement (e.g., via change in the video signal exceeding a threshold) within the video frame (field of view). As another example, an IoT temperature sensor can be configured to transmit substantially continuous or periodic temperature readings, or can be configured to transmit an alert signal only upon detecting that a measured temperature falls below or above a threshold temperature value.

IoT devices can be configured as network devices, including repeaters, hubs, network switches, routers, splitters, and combiners. As an example, an IoT device can be a standalone repeater, or as a multipurpose device that includes a repeater, that is placed in a home or business premises at a location near an IoT device that is not powered from provided energy (e.g., not plugged in to an AC power outlet or DC power jack) and that is therefore configured to weakly transmit communication signals so as to conserve power. The weak transmission may be such that it cannot reliably be received from a more distant network device, such as a Wi-Fi router that provides a connection to network 118 in the multimedia/IoT environment 102 of FIG. 1. Accordingly, a media/IoT system 104 may advise a user to place an IoT device

IoT devices can be configured as information output devices, including a video display (e.g., a television screen, a computer monitor, or a display of a mobile device), a video projector, a smart mirror, a loudspeaker (e.g., an alarm siren), or a clock (e.g., an alarm clock). Output devices can show or tell warnings or alerts corresponding to conditions triggered by sensors or devices in the IoT system, and/or can act as elements of user interfaces by which the user 132 can access configuration settings and options associated with the IoT system. Video displays can be configured to provide visual feedback as part of the IoT system during user control input operation. Similarly, loudspeakers can be configured to provide verbal feedback as part of the IoT system during user control input operation.

IoT devices may require electrical energy to perform their measurement, reporting, communication, and/or actuation functions. Energy used by the IoT devices can be broadly categorized as provided energy 140 or harvested energy 138. Provided energy 140 is sourced from a sustained power source, such as AC mains, for example by the IoT device being directly wired into an AC electrical distribution system of a home or business premises, or by being plugged into an AC power outlet or DC power jack. By contrast, harvested energy is energy that is converted to electrical energy from some other ambient or directed energy form by an energy transducer that is integrated within the IoT device. One or more of the IoT devices 132, 134, 136 can be equipped with one or more energy transducers so as to be operable using harvested energy 138 absent a reliable source of provided energy 140.

Example energy transducers that IoT devices can be equipped with can include photovoltaic cells (e.g., bifacial solar cells), photoelectrochemical cells, piezoelectric transducers, electromagnetic generators and kinetic or vibrational energy harvesters (e.g., solenoids, rotary generators, wind turbines, hydroelectric generators), triboelectric nanogenerators, thermoelectric generators, pyroelectric devices, RF energy harvesting antennas, electrostatic energy harvesting devices, microbial fuel cells, and radioisotope thermoelectric generators.

The block diagram of FIG. 2 illustrates an example media device/IoT controller 106, according to some embodiments. Media device/IoT controller 106 may include a streaming module 202, a processing module 204, storage/buffers 208, and a user interface module 206. The processing module 204 may execute instructions, such as may be stored in storage/buffers 208, to carry out media functions and/or IoT system functions. Media functions include selection and playback of digital media, such as streaming media, and provision of a user interface to aid in such selection and playback (including pausing, rewinding, fast-forwarding, and other functions, such as turning on or off captions, changing audio streams, or adjusting display parameters). IoT system functions include IoT system setup and calibration, IoT device health monitoring (including energy charge status monitoring), IoT device recharge need prediction, IoT sensor data collection, IoT sensor data compositing, IoT sensor data analysis, IoT sensor data display, IoT device recharge planning, IoT device command formulation, IoT system user interface functions, and IoT system alert processing. As described above, the user interface module 206 may include an audio command processing module 216. The media device/IoT controller 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, as examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX.

Now referring to both FIGS. 1 and 2, in some embodiments, a user 132 may interact with the media device/IoT controller 106 via, for example, the remote control 110. For example, the user 132 may use the remote control 110 to interact with the user interface module 206 of the media device/IoT controller 106 to select content, such as a movie, TV show, music, book, application, game, or recorded IoT sensor data. As another example, the user 132 may use the remote control to access a graphical user interface to perform setup, monitoring, and control functions associated with IoT devices or the larger IoT system or network. The streaming module 202 of the media device/IoT controller 106 may request selected content from the content server(s) 120 over the network 118. The content server(s) 120 may transmit the requested content to the streaming module 202. The media device/IoT controller 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device/IoT controller 106 may store the content received from content server(s) 120 in storage/buffers 208 for later playback on display device 108.

### Energy-Harvesting and Energy-Transmitting IoT Devices

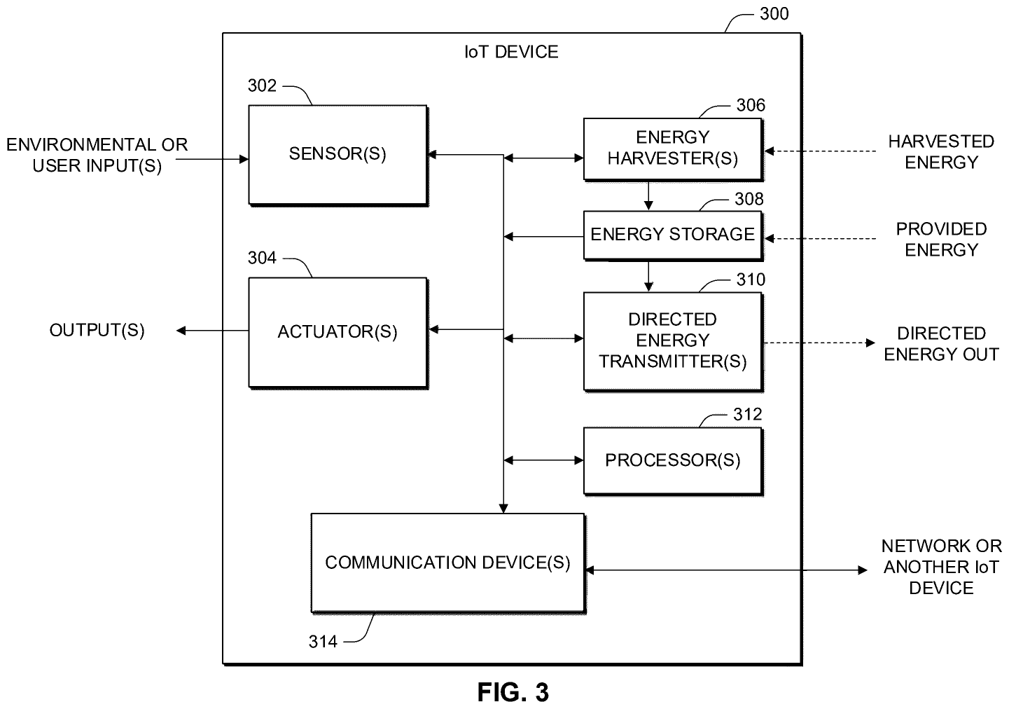

The block diagram of FIG. 3 illustrates an example IoT device 300, according to some embodiments. For example, any of IoT devices 132, 134, or 136 of FIG. 1 can be configured as an instance of IoT device 300. In some examples, an IoT device 300 can have one or more sensors 302 capable of detecting one or more environmental or user inputs. For example, an IoT device 300 configured as an air quality sensor can have a sensor 302 that includes a laser-based or electrochemical-based apparatus for detecting particulate matter in the air. As another example, a sensor 302 of an IoT device 300 configured as a light switch can detect the state of a physical switch set by a user. In some examples, an IoT device 300 can have one or more actuators 302 configured to provide one or more outputs. As an example, an IoT device 300 configured as a garage door opener may have a door drive motor as an actuator 304. As another example, an access control IoT device 304 can have an electromagnet as an actuator 304 that can hold a door closed to prevent access unless and until authorized by an input. The one or more actuators 304 can include one or more displays or one or more transducers. For example, an IoT device 300 may be configured to provide no other output than a visual display on a screen or light-emitting diode or other lamp, or an audible alert on a loudspeaker.

In some examples, an IoT device 300 can have one or more energy harvesters 306 capable of transducing harvested energy, which can include ambient energy present in the environment (e.g., solar energy, wind energy, or thermal energy), directed energy (e.g., RF or optical energy transmitted from another device in the IoT system), user-provided energy (such as from a user flipping a switch, opening a door or window, or walking on a floor), or energy sourced some other way (e.g., siphoned from motion generated by a motor, such as a garage door opener drive or a water pump). In some examples, the sensor 302 and the energy harvester 306 can be one and the same, as, for example, in an IoT device 300 configured as a light detector, where a photocell provides both environmental sensory input and harvested energy transduction, or a wind detector, where an anemometer or wind turbine can both measure wind speed and harvest wind energy.

In some examples, an IoT device 300 can have energy storage 308. Energy storage 308 can store provided energy from an AC or DC power source, store harvested energy from energy harvester(s) 306, supply energy for operation of the IoT device 300, and/or be transmitted to one or more other IoT devices via directed energy transmitters 310. The energy storage 308 can include, as examples, a battery, a supercapacitor, or a mechanical energy storage device such as a spring winding. A supercapacitor can provide advantages of larger storage capacitor and faster charging than a conventional capacitor.

In some examples, an IoT device 300 can have one or more directed energy transmitters 310 configured to retransmit energy stored in energy storage 308 and/or provided energy from an AC or DC power source. The one or more directed energy transmitters 310 can, as examples, be one or more RF transmitters having antennas capable of generated focused RF energy, and/or can be one or more optical devices, such as one or more infrared lasers. The directed energy can be directed at a user-set or automatically determined, estimated, or predicted location of another IoT device in the IoT system that may be in need of energy. The other IoT device may use its own energy harvester 306 to collect the directed energy and use or store it for later use.

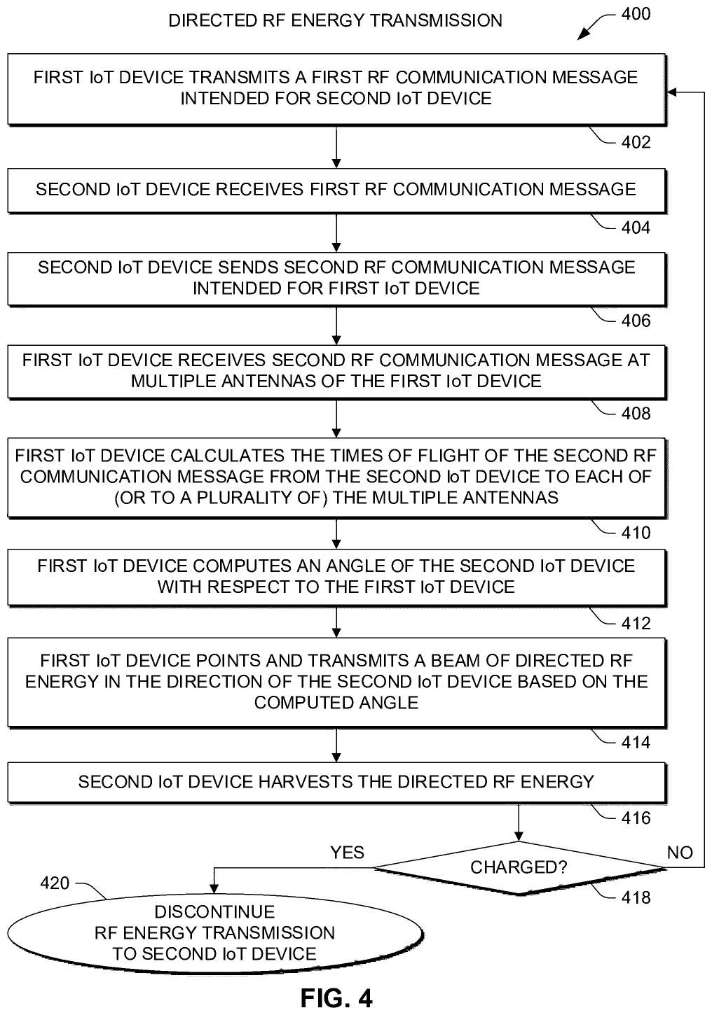

In an example of RF energy transmission from a first IoT device (the energy source) to a second IoT device (the energy target), a feedback method can be used to beam-form RF energy, focusing its transmission to the second IoT device. The flow chart of FIG. 4 illustrates an example feedback method 400 for beam-forming RF energy for transmission from a first IoT device to a second IoT device. In the example method 400, the first IoT device may transmit 402 a first RF communication message intended for the second IoT device. The first RF communication message may include an instruction prompting the second IoT device to respond with a second RF communication message addressed to the first IoT device. The second IoT device can receive 404 the first RF communication message and, based on receiving the first RF communication message, send 406 a second RF communication message intended for the first IoT device. The first IoT device can receive 408 the second RF communication message at multiple RF antennas and can calculate 410 the times of flight of the second RF communication message from the second IoT device to each of (or to a plurality of) the multiple RF antennas. Based on the calculated times of flight, the first IoT device can compute 412 an angle of the second IoT device with respect to the first IoT device, e.g., using phase-shift or phase-difference measurements.

The first IoT device can then point and transmit 414 a beam of directed RF energy in the direction of the second IoT device based on the computed angle. The second IoT device can then use an energy harvester 306 configured for RF energy harvesting (e.g., including an RF antenna) to harvest 416 the directed RF energy. The first IoT device can determine 418 whether or not the second IoT device is fully or sufficiently charged, for example, based on a charging model known to the first IoT device, or based on a message sent from the second IoT device to the first IoT device.

Based on a determination 418 that the second IoT device is not fully or sufficiently charged, the first IoT device can continue the directed RF energy transmission. In examples where the second IoT device is not stationary, more or more of the actions 402, 404, 406, 408, 410, 412, 414, and 416 can be iteratively repeated so as to track the direction of the transmitted RF energy with the motion of the second IoT device. Based on a determination 418 that the second IoT device is fully or sufficiently charged, the first IoT device can discontinue 420 the RF energy transmission. The beam-formed direction of the transmitted RF energy effectively increases the amount of power delivery to the second IoT device, as compared to RF transmission methods that do not direct energy at the energy target. As one example, a television 108 or other media device/IoT controller 106 of a media/IoT system 104 can be equipped for directed RF energy transmission to charge energy storage of a remote control 110 or other IoT device 300 left placed in the vicinity of the television 108 or other media device/IoT controller 106.

In some examples, IoT devices, such as IoT devices configured with RF energy transmitting capabilities, can be installed behind drywall of new construction or during a home or business premises renovation. In such examples, such an IoT device may still be wired to the AC power distribution system of the home or business premises. In such examples, an IoT RF energy transmitter can advantageously be placed unobtrusively and in a manner that does not substantially reduce the RF transmission strength of the transmitter.

Returning attention to FIG. 3, in some examples, an IoT device 300 can have one or more processors 312 configured to process signals collected by the one or more sensors 302 and/or the one or more communication devices 314, to issue command signals to the one or more actuators 304, and/or to determine an energy or charging status or health of the energy storage 308. The one or more processors 312 can include one or more general-purpose computer processors, digital signal processors, application-specific integrated circuits, field-programmable gate arrays, and stream encoders and/or decoders, as examples. The one or more processors 312 can be provided as a single integrated circuit device or as multiple distinct integrated circuit devices. The one or more processors can be coupled to and/or can include a memory (not shown in FIG. 3), such as a non-volatile memory. The one or more processors 312 can be configured to direct the activities of the IoT device 300, including activities for servicing the charging of the IoT device 300. For example, the one or more processors 312 can receive a signal from energy storage 308 indicating a low energy status and direct the issuance of a signal via the communication device 314 indicative of the low-energy status, effectively requesting recharge from another IoT device or from a user.

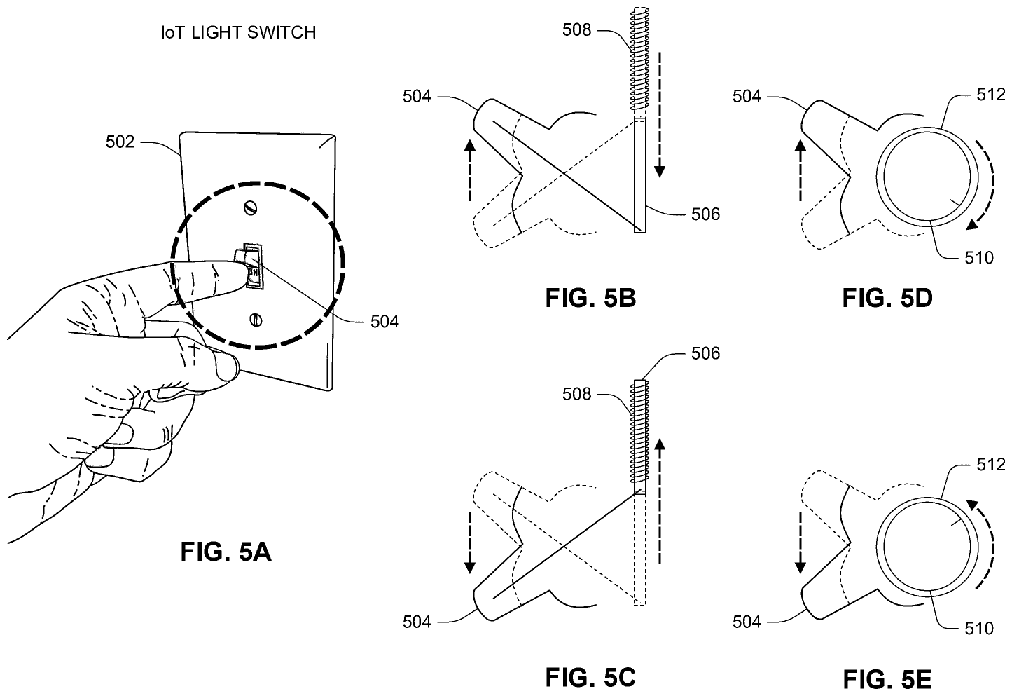

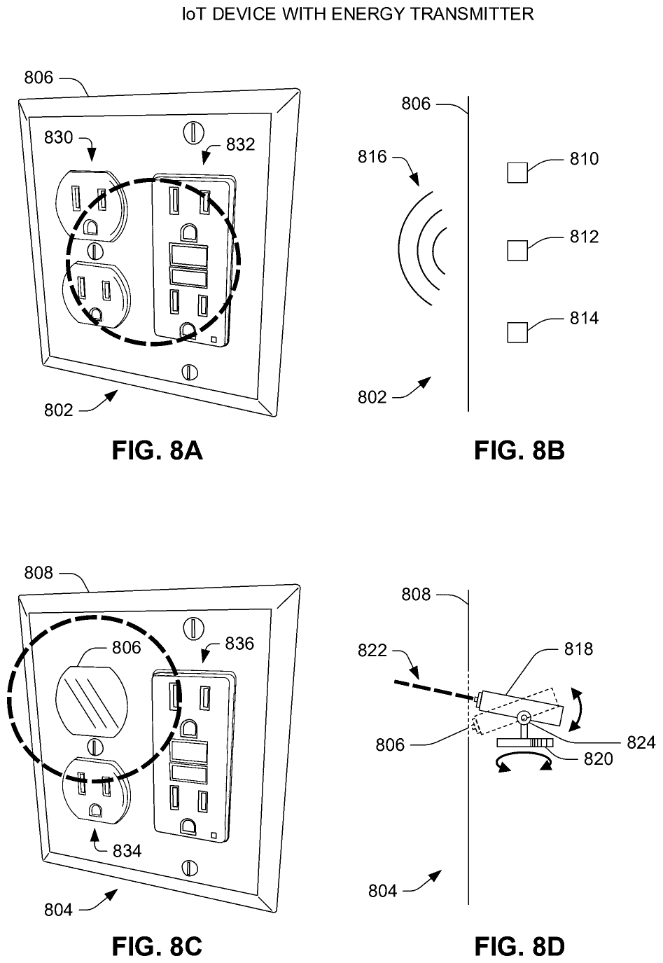

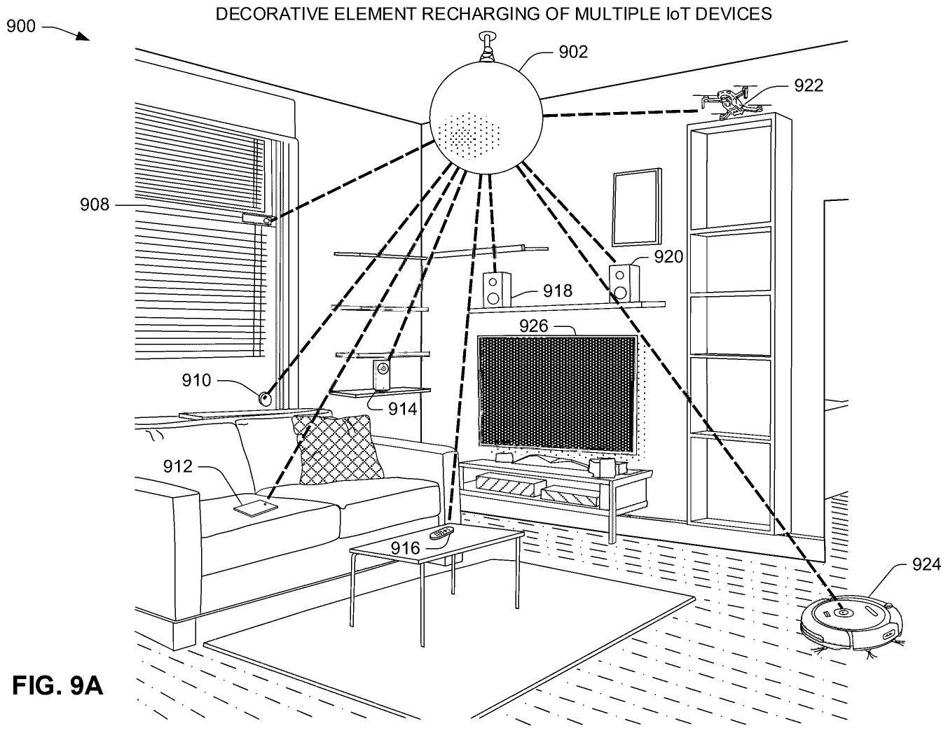

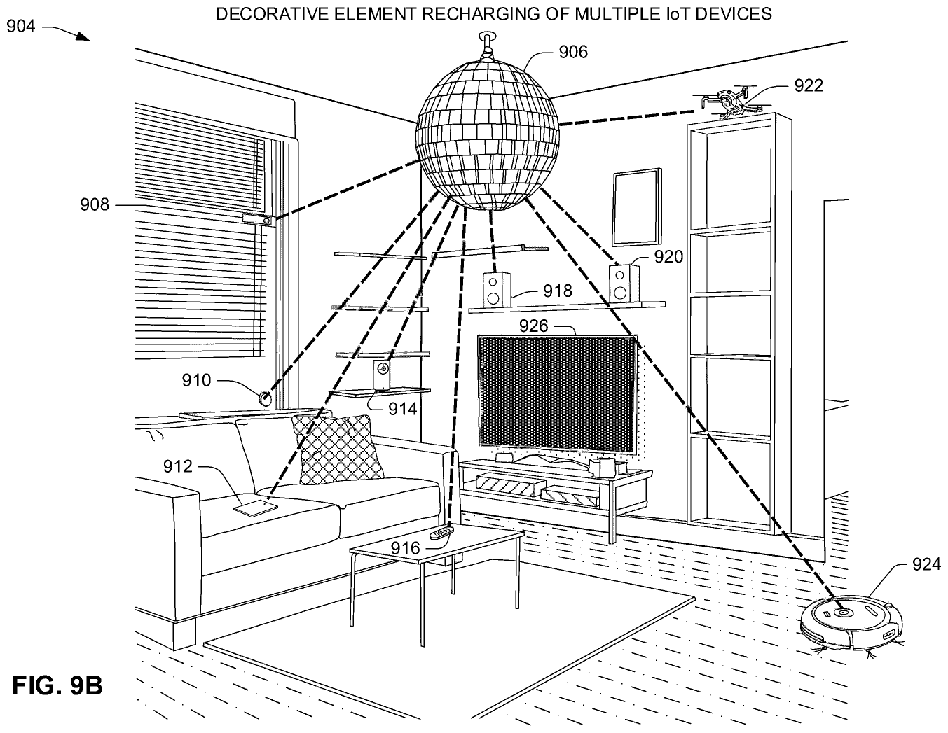

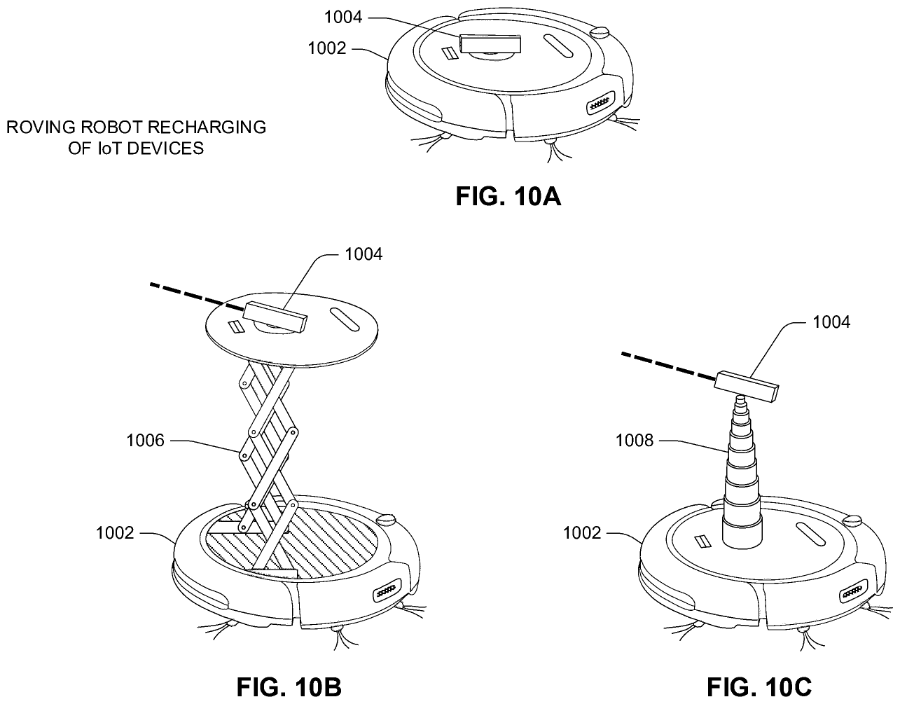

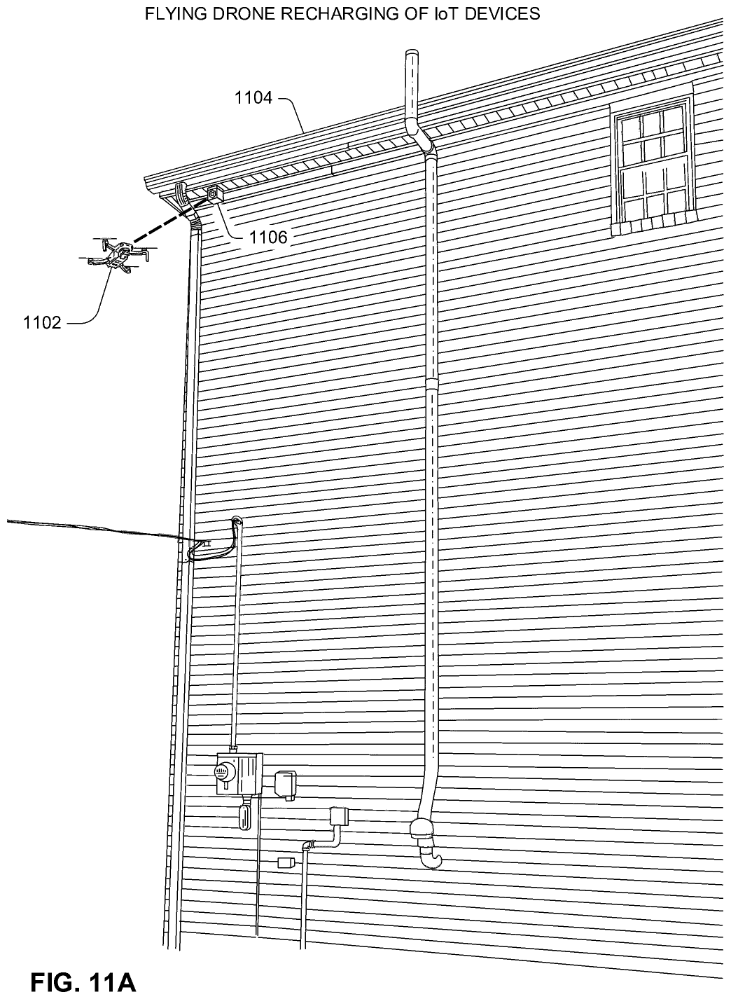

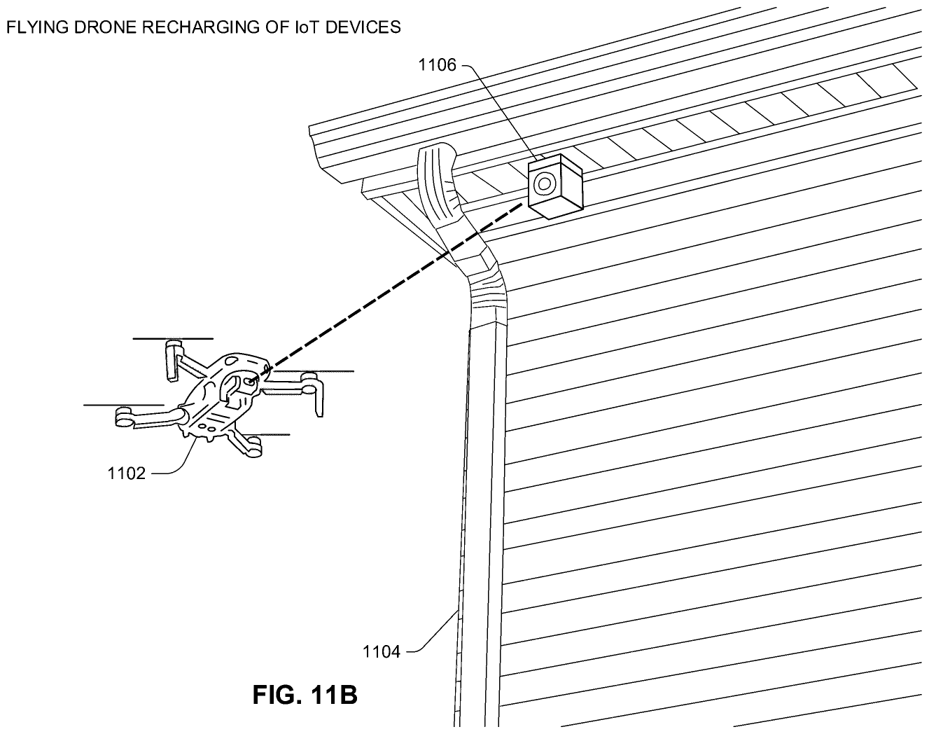

In some examples, an IoT device 300 can have one or more communication devices 314 configured to transmit and/or receive signals to a network, such as network 118 of FIG. 1, and/or to other IoT devices 300, which can be configured as signal repeaters as their dedicated or secondary functions. The one or more communication devices 314 can be, as examples, RF or optical communication devices. In some examples, the one or more communication devices 314 can include or make use of apparatus used by the one or more directed energy transmitters 310. As examples, antennas used for directed RF energy transmission can also be used for RF communication signal transmission, or an optical beam emitter (e.g., a laser) used for directed optical energy transmission can also be used for optical communication signal transmission. As an example, an IoT device 300 configured as a television remote control 110 can include an infrared light-emitting diode (LED) that can be used both to transmit communication signals (e.g., to a TV 108 or media device/IoT controller 106) and to transmit energy optically to another IoT device 300 such as any of IoT devices 132, 134, 136 in FIG. 1. As another example, an IoT device 300 configured as a television remote control 110 can include an LED that can be used both to transmit communication signals (e.g., to a TV 108 or media device/IoT controller 106) and to harvest energy optically from another IoT device 300 such as any of IoT devices 132, 134, 136 in FIG. 1, 502 in FIG. 5A, 802 in FIGS. 8A and 8B, 804 in FIGS. 8C and 8D, 902 or 926 in FIG. 9A, 906 or 926 in FIG. 9B, 1002 in FIGS. 10A, 10B, and 10C, and/or 1102 in FIGS. 11A and 11B. As another example, an IoT device 300 configured as a television remote control 110 can include an LED that can be used to transmit communication signals (e.g., to a TV 108 or media device/IoT controller 106), to transmit energy optically to another IoT device 300 such as any of IoT devices 132, 134, 136 in FIG. 1, and to harvest energy optically from another IoT device 300 such as any of IoT devices 132, 134, 136 in FIG. 1, 502 in FIG. 5A, 802 in FIGS. 8A and 8B, 804 in FIGS. 8C and 8D, 902 or 926 in FIG. 9A, 906 or 926 in FIG. 9B, 1002 in FIGS. 10A, 10B, and 10C, and/or 1102 in FIGS. 11A and 11B.

In some examples, an IoT device 300 may have any or all of its components 302, 304, 306, 308, 310, 312, 314 and connections housed within a single housing such that the IoT device is conveniently integrated as a single unit or module. In some examples, the IoT device can be placed in a home or business premises and its presence and location automatically detected by a larger IoT system with minimal or no additional effort on the part of the user during setup. In some examples, an IoT device 300 may have one or more of its components located outside its housing. For example, an energy harvester 306 configured as a photovoltaic cell may be wired to, but movably independent from, a housing containing the other components of the IoT device 300, so as to aid placement and orientation of the photovoltaic cell to collect a greater amount of sunlight.

In some examples, an IoT device 300 may omit one or more of sensor(s) 302, actuator(s) 304, energy harvester(s) 306, energy storage 308, directed energy transmitter(s) 310, or processors 312. For example, an IoT device 300 configured as a security camera may omit actuator(s) 304, as it may have no other output than its video signal provided via its communication device 314. As another example, an IoT device 300 configured as a stand-alone dedicated signal repeater may omit sensor(s) 302 and actuator(s) 304 as neither is needed for receiving and sending IoT communications signals. An example IoT device 300 configured to be plugged in or wired to a reliable AC or DC power connection may omit energy harvester(s) 306.

An example IoT device 300 not configured to be wired to a reliable AC or DC power connection may omit directed energy transmitter(s) 310 if it is expected that harvested energy will be insufficient to make retransmission of the energy to another IoT device practicable. An IoT device 300 may omit energy storage 308 where provided energy is available, making energy storage 308 unnecessary, or where harvested energy can be expected to be sufficiently present during periods of IoT device operation such that energy storage 308 is unnecessary, as may be the case in IoT devices 300 configured as sensors to sense certain conditions that themselves may provide energy, such as a fire or flood detector. Provided energy need not be provided to energy storage 308 but in some examples can be provided directly to other components of the IoT device 300 via appropriate circuitry, such as converters, filters, wires, and traces (not shown).

To facilitate operation under solely harvested-energy conditions, IoT device 300 can employ power reduction strategies, including particular circuitry and transmission protocols. As one example, the one or more sensors 302, the one or more processors 312, and/or the one or more communication devices 314 can be selected to be of the type that operate with extremely low power expenditure. For example, the processor 312 can be selected to be capable of powering up and expending substantial energy only when in use to execute processing tasks, and to consume no power or reduced power when otherwise in a wait or sleep state.

As another example, a communication protocol between IoT devices can be tailored for reduced power operation. For example, during an initial setup of an IoT environment 102, an IoT controller 106 can become aware of unique message sequences transmitted by individual IoT devices in the environment 102. The unique message sequences can be generated, e.g., using a pseudorandom number sequence generator. The unique message sequences can be transmitted as ping messages to indicate that the transmitting IoT device is still “alive” within the environment 102 (e.g., powered and functional). Ping messages may also be used to indicate IoT device location (e.g., relative direction between devices) as described above with regard to FIG. 4. The ping messages can be transmitted intermittently, periodically, or upon request from another device. The ping messages can be made to be a very small number of bits, e.g., 16 bits, so that harvested-energy IoT devices consume very little power pinging. Harvested-energy IoT devices within the environment 102 that ping more often than other harvested-energy IoT devices can be assigned ping messages with shorter number of bits so that their ping messages are the least power-consumptive.

In some embodiments, IoT devices can harvest energy from mechanical motion that is inherent to their function or that is readily sourceable from the environment. FIG. 5A illustrates an example IoT device configured as an IoT light switch 502 (or switch for another appliance). The IoT light switch 502 may be integrated into its IoT environment 102 in a way such that it is not practicable for the light switch 502 to be powered by direct connection to a reliable AC or DC power source. For example, the IoT light switch may be installed after design and/or installation of an AC power distribution network in a home, in a location not having wiring required to power the switch, such that redesigning or modifying the AC power distribution infrastructure would incur added cost that could be reduced or eliminated by use of a harvested-energy IoT light switch 502. The IoT light switch 502 may be equipped with a state sensor 302 such as a mechanical lever 504 that can double as a part of an energy harvester 306, and may also be equipped with a communication device 314 configured to transmit messages indicative of the state of the state sensor 302 to thereby activate or deactivate a light (or other appliance). Regular user engagement of the mechanical lever may provide sufficient energy to power the communication device 314 and other components of the IoT light switch 502.

As examples, the energy harvester 306 of the IoT light switch 502 can transduce user switching action from mechanical to electrical energy via a linear transducer, as shown in FIGS. 5B and 5C, or a rotational transducer, as shown in FIGS. 5D and 5E. In the example of FIGS. 5B and 5C, the motion of the mechanical lever 504 translates a magnetic rod 506 into and out of a conductive solenoid 508, inducing electrical current in the solenoid that can be harvested to an energy store or used immediately to perform an instantaneous sense-and-transmit function. For example, an instantaneous sense-and-transmit function can include turning on a processor 312 of the IoT light switch 502 and send a packet via a communication device 314 of the IoT light switch 502.

In the example of FIGS. 5D and 5E, the motion of the mechanical lever 504 rotates a rotor 510 of a generator also having a stator 512. The rotational motion of the rotor 510 within the stator 512 produces a magnetic force that induces electrical current in conductive coils wound together housing an iron core in the stator 512, which current can be harvested to an energy store or used immediately to perform an instantaneous sense-and-transmit function. In other examples (not shown), a friction generator that employs the triboelectric effect can be used as the transducer in IoT light switch 502. In still other examples, other mechanical-to-electrical transduction modes can be used. In other examples, not illustrated, the rotational motion of a dimmer dial or the translational motion of a fader control can be harvested as electrical energy to power an associated IoT control device.

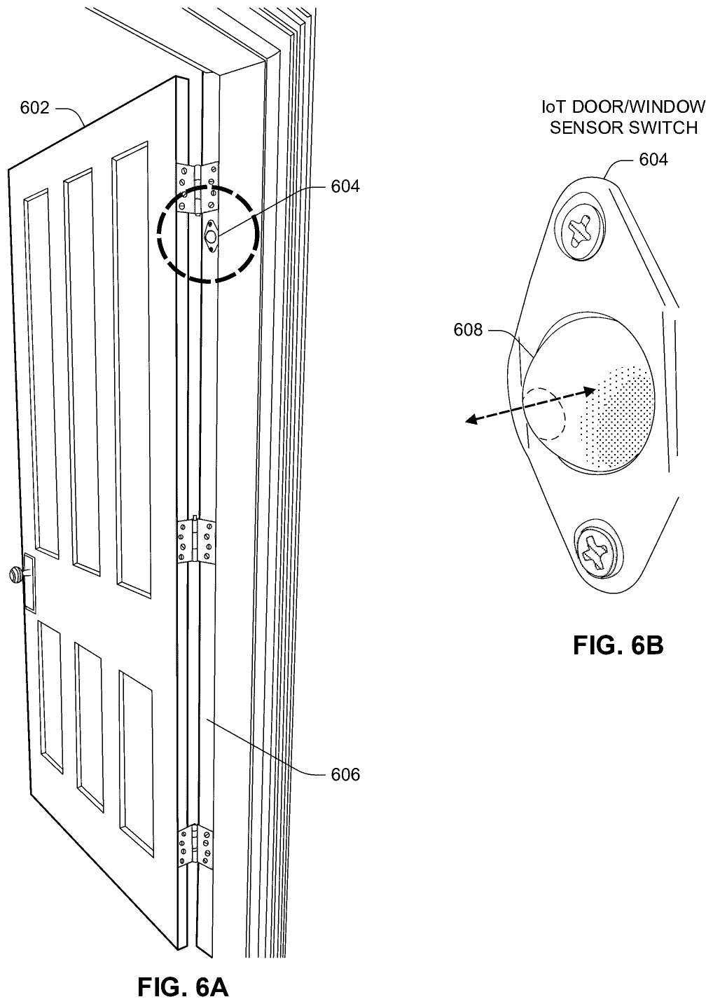

FIGS. 6A and 6B illustrate an IoT door or window switch sensor 604 as another example IoT device that can harvest energy from mechanical motion that is inherent to its function or that is readily sourceable from the environment. The IoT door or window switch sensor 604 can detect whether a door or window is open or closed. FIG. 6B shows a zoomed-in view of the switch sensor 604, which is highlighted in the wider view of FIG. 6A by the circled portion of FIG. 6A. FIG. 6A shows the IoT switch sensor 604 installed in a frame 606 of a door 602. In other examples, not illustrated, the IoT switch sensor 604 can be installed in a sill of a window, or in other locations where a button 608 of the switch sensor 604 may be depressed. The button 608 is illustrated as being rounded or spherical in shape, but in other examples can take on different shapes and configurations.

The IoT switch sensor 604 is installed to be flush with the door frame 606 so as not to interfere with the complete closing of the door 602. The button 608, however, extends outward (e.g., by an internal spring, not shown) when the door 602 is open and retracts into the IoT switch 604 when depressed into the plane of the door frame 606 by the closing of the door 602. The depressing of the button 608 can be sensed by a sensor 302 of the IoT switch sensor 604, thereby generating a signal that can be communicated by a communication device 314 of the IoT switch sensor 604. The mechanical motion of the depression of the button 608, indicated by the double-headed broken-line arrow in FIG. 6B, can be transduced into electrical energy, using one or more transduction mechanisms described above. The transduced electrical energy can be harvested to an energy store inside the IoT switch sensor 604 or used immediately to perform an instantaneous sense-and-transmit function of the IoT switch sensor 604.

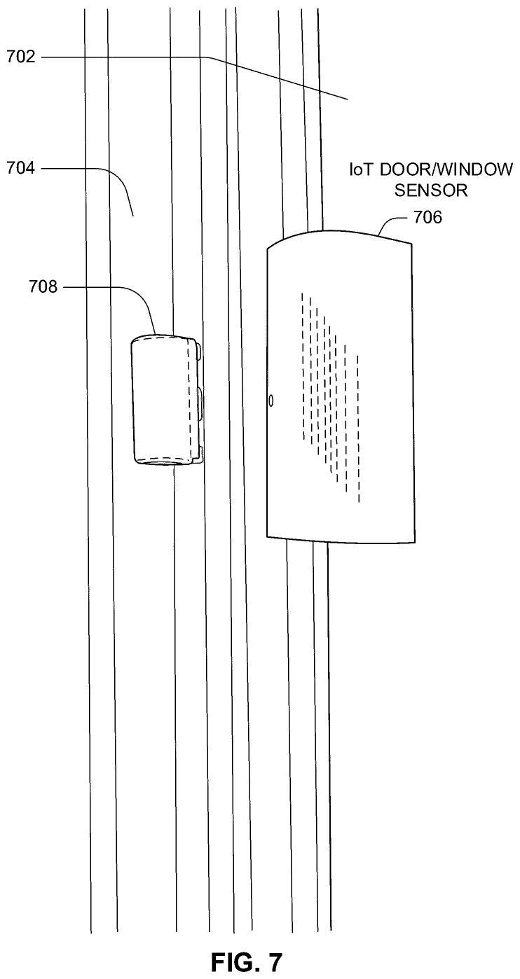

FIG. 7 illustrates an IoT door or window sensor 706 as another example IoT device that can harvest energy from mechanical motion that is inherent to its function or that is readily sourceable from the environment. IoT door or window sensor 706 is installed on the edge 702 of a door or window that is in a closed position, substantially adjacent to a magnet portion 708 installed on the door frame or windowsill 704 very near to the IoT door or window sensor 706. The magnet portion 708 can be completely passive and require no power to operate. Proximity of the magnet portion 708 to the IoT door or window sensor 706, indicative of a closed door or window, closes a reed switch in the IoT door or window sensor 706, thus closing an electrical circuit in the IoT door or window sensor 706 and permitting a current to circulate in the IoT door or window sensor 706.

Opening the door or window sufficiently removes the magnet portion 708 from proximity to the IoT door or window sensor 706, thus opening the reed switch in the IoT door or window sensor 706, opening the electrical circuit and ceasing the circulation of the current in the circuit. The cessation of current circulation is sensed and indicates an open door or window. Motion of the magnet portion 708 with respect to the IoT door or window sensor 706 can also induce a current in an energy harvesting device or circuit of the IoT door or window sensor 706. The transduced electrical energy can be harvested to an energy store inside the IoT switch sensor 604 or used immediately to perform an instantaneous sense-and-transmit function of the IoT switch sensor 604.

Other IoT devices can similarly be used to harvest energy. Some IoT devices can be batteryless sensors that require zero stored electrical energy for communicative operation. As one example, a batteryless IoT garage door opening sensor can be configured similarly to any of the sensors described above with regard to FIGS. 5 through 7 and placed on the rail of a garage door. When a wheel of the garage door moves over the IoT garage door opening sensor in one direction, the transduced mechanical motion of the sensor suffices to power circuitry of the sensor and transmit a packet reporting the opening of the garage door. When the wheel of the garage door moves over the sensor in the opposite direction, the transduced mechanical motion of the sensor again suffices to power circuitry of the sensor and transmit a packet reporting the closing of the garage door. Such a device may be IoT enabled without requiring either provided energy 140 or energy storage 308.

As another example, an IoT device can be installed on or near a hinge of a door, and harvest energy from the mechanical motion of the hinge. As another example, an IoT device can be installed as part of a door closer, which is a piston-like device that helps to soften the closing of a door to prevent slamming. The IoT device can be configured with energy-harvesting apparatus that can recapture energy as the door is closing. A similar device could likewise be installed on a window. As another example, an IoT device can be one that a pet interacts with, such as a pet feeder, and can be configured to harvest energy from mechanical motion induced by the pet. As another example, an IoT device can be built into a floor, and can be configured to harvest energy from the pressure or wave motion associated with walking on the floor. For example, a deflection piezoelectric transducer can be used to harvest energy from floor deflection.

As another example, an IoT device can be installed in a location expected to have a sizeable heat differential, and can be configured with energy harvesting apparatus that can harvest energy from the heat differential. As examples, a window sensor on a window may capture energy from the heat differential inside and outside the window, or a hot water heater sensor may capture energy from the heat differential inside and outside the hot water heater. Such examples may include as energy harvesting apparatus that pyroelectric generators, thermoelectric generators that make use of the Seebeck effect or the Peltier effect, or thermionic converters (where a vacuum is involved). As another example, an IoT device can be configured to transduce minute air pressure changes, such as those associated with sound waves, into electrical energy. As another example, an IoT device can be configured to transduce amplitude-modulated (AM) radio waves into electrical energy.

Energy-harvesting IoT devices can advantageously be provided with bifacial solar cells that can reduce the overall solar cell surface area necessary to provide for the power budget of the IoT device. As examples, a security camera or remote control can include a bifacial solar cell.

Some embodiments can include single-use wireless sensors, such as fire or flood detectors, that are powered only by energy inherent in or derived from their triggering events. For example, a fire detection sensor can harvest energy from heat or a temperature differential associated with a fire. For example, a fire detection sensor can include a thermal expansion material that expands when exposed to heat. The mechanical expansion of the thermal expansion material can be harvested as mechanical energy and transduced into sufficient electrical energy to transmit a message (e.g., a data packet) indicating that that a fire is detected. As another example, a flood detection sensor can harvest energy associated with soaking. For example, a flood detection sensor can include a hygroscopic expansion material that expands when soaked with water. The mechanical expansion of the hygroscopic expansion material can be harvested as mechanical energy and transduced into sufficient electrical energy to transmit a message (e.g., a data packet) indicating that that a flood is detected. In either case, a chemical reaction, rather than a mechanical expansion, can be induced from the condition being sensed, from which energy can be harvested by the wireless sensor. In either case, the sensor can be made to be single-use. In some examples, a media device/IoT controller 106, in receipt of the message indicating the occurrence of the sensed event from the single-use sensor, may automatically place an order over the internet for a replacement sensor with a vendor.

### Automated Recharging of Harvested-Energy IoT Devices

As noted above, some harvested-energy IoT devices can be provided with energy-harvesting apparatus and functionality capable of harvesting energy from their environments or from their regular use. Some harvested-energy IoT devices can alternatively or additionally be provided with energy-harvesting apparatus and functionality capable of accepting received energy transferred from another device, such as another IoT device. For example, an IoT controller 106 of a media/IoT system 104 can control automated recharging of harvested-energy IoT devices within the multimedia/IoT environment via one or more stationary recharge points and/or mobile recharging robots that can have one or several of various modes of mobility. Stationary recharge points can be located at places within or around a home or business premises in proximity to locations where energy-harvesting IoT devices may reside and may use the stationary recharge points to recharge. Mobile robots may travel to the locations of IoT devices to more effectively recharge them from a proximate but not adjacent position. Recharging can be performed in a pre-set fashion, according to schedules, adaptively, or predictively, and can be based on pre-set or adaptive priority values or rules to triage the recharging of IoT devices.

Stationary recharge points may be IoT devices that are generally operative using provided energy (e.g., are powered by being plugged in or wired to an AC or DC power distribution network of the home or business premises). The coupling to an AC or DC power distribution network provides the advantage of an effectively unlimited supply of power with which to recharge other devices. In some examples, stationary recharge points may themselves operate additionally or solely off of harvested energy. Stationary recharge points can offer direct, conductive transfer of electrical energy, as with a docking station or base station for a mobile robot (e.g., robotic vacuum cleaner or flying drone), inductive power transfer (e.g., a charging pad), and/or more remote transfer of energy by focused-beam RF transmission or optical beam emission.

Stationary recharge points can be single-function or can have multiple functions as IoT devices. Stationary recharge points can be integrated with furniture, appliances (e.g., wall-mounted or ceiling-mounted appliances such as electrical outlet receptacles or lighting receptacles), or decorative elements (e.g., lighting fixtures, globes, and mirrored balls), or can be placed inside of walls (e.g., behind drywall), so as to unobtrusively supply energy within an IoT environment 102.

FIGS. 8A through 8D illustrate example stationary recharge points 802, 804 configured as or integrated with AC power receptacles. The example stationary recharge points 802, 804 are configured to be capable of directed energy transmission to nearby IoT devices (e.g., within the same room, e.g., within several meters of distance). FIGS. 8A and 8B illustrate an example stationary recharge point 802 that includes a focused-beam RF energy transmitter, whereas FIGS. 8C and 8D illustrate an example stationary recharge point 804 that includes an optical beam emitter.

FIG. 8A is an external perspective view of an example stationary recharge point 802 integrated in an AC power outlet receptacle appliance. The illustrated example has four AC outlets, two configured as conventional AC outlets 830 in a first receptacle and two configured as ground-fault circuit interrupter (GFCI) AC outlets 832 in a second receptacle, but other example appliances may have other arrangements of outlets or receptacles, including more or fewer AC outlets or receptacles. As shown in the side view of FIG. 8B, RF antennas 810, 812, 814 are located behind face plate 806, which is plastic or another material that is substantially transparent to RF energy. As an example, the RF antennas can be arranged as a phased array antenna system. The RF antennas 810, 812, 814 can be located, for example, in the space between outlets in the general area encircled in FIG. 8A, or otherwise in or around the outlet receptacles. The illustrated example of FIG. 8B includes three antennas, but in other examples, fewer antennas or more RF antennas (at least two) may be used. The RF antennas can be controlled by RF circuitry (not shown), which may include a processor 312, to focus a main lobe of an RF transmission pattern (an “RF beam”) 816 toward an energy-harvesting IoT device to be charged (the target device). For example, the stationary recharge point 802 can use the method 400 of FIG. 4 to direct the RF beam toward the target device.

FIG. 8C is an external perspective view of an example stationary recharge point 804 integrated in an AC power outlet receptacle appliance. The illustrated example has three AC outlets, one configured as a conventional AC outlet in a first receptacle 834 and two configured as GFCI AC outlets in a second receptacle 836. Other example appliances may have other arrangements of outlets or receptacles, including more or fewer AC outlets or receptacles. As shown in FIG. 8C, one space where an outlet would be is replaced by a void space or window 806 behind which an optical beam 822 may be emitted. For example, the window 806 can be translucent or transparent to a wavelength spectrum within which optical energy is principally transmitted by the stationary recharge point 804.

As shown in the side view of FIG. 8D, an optical beam emitter 818 (e.g., a laser, such as an infrared laser) is positioned behind the void space or window 806 to create the optical energy beam 822. In the illustrated example, the beam 822 is directed (steered) toward an energy-harvesting IoT device with an azimuth actuator 820 and an altitude actuator 824 to adjust the horizontal direction and the vertical direction, respectively, of the beam 822. In other examples, the beam 822 may be directed (steered) toward an energy-harvesting IoT device in other ways, such as by using adjustable mirrors, prisms, lenses, or rotating diffraction gratings. Other examples of optical beam steering approaches include mechanical mirror-based gimbals or beam-director units, galvanometer mechanisms that rotate mirrors, Risley prisms, phased-array optics, and microelectromechanical systems using micro-mirrors. Steering commands to control the optical beam steering apparatus can, for example, be generated and issued by a processor 312.

The optical beam emitter 818 can be controlled by optical beam circuitry (not shown) to focus the optical RF beam 822 toward a target device. As an example, the stationary recharge point 804 can use a search pattern (e.g., a spiral search pattern, a sweep search pattern, or a scan search pattern) to improve or optimize a direction of the optical beam 822 toward the target device. In some examples, the target device can provide feedback about strength of optical energy received or recharge speed, corresponding to an accuracy of beam direction, to the stationary recharge point 804 via RF communication during the stationary recharge point's conducting the search pattern. For example, a strength of energy harvesting or recharge speed corresponding to an accuracy of beam direction can be regularly reported from the IoT device to be charged to the stationary recharge point 804 while the stationary recharge point 804 executes a steering optimization method. Additionally or alternatively, the optical beam emitter 818 or other part of the stationary recharge point 804 can include a sensor (not shown) configured to sense a reflection of the optical beam 822 from a retroreflector on the target device. The stationary recharge point 804 can determine that the aim of the optical beam 822 is accurate when the sensor senses the retroreflection of the beam 822. In some examples, the stationary recharge point 804 can be configured to increase beam power (e.g., to a maximum value) when beam aim is determined to be accurate, and reduced (e.g., to zero) when beam transmission is subsequently interrupted, as by a passing person or pet, as a safety measure.

In some examples, stationary recharge points, such as those described with reference to FIGS. 8A through 8D, can be advantageously located and oriented so as to be able to recharge energy-harvesting IoT devices placed nearby, such as an IoT window sensor on a window in a wall opposite an IoT AC power outlet 806 or 808 configured as a stationary recharge point. In some examples, stationary recharge points can be integrated into other appliances or household objects, such as light switches, ceiling fans, table lamps, and active furniture (e.g., power-outlet-equipped tables, desks, dressers, or couches, or motorized or heated recliners, chairs, or beds). A stationary recharge point can also be configured as a stand-alone pluggable module that can be plugged into an existing AC power outlet or DC power jack.

Stationary recharge points, such as may use RF or optical transmission to transfer power, can be integrated into decorative elements so as to blend into the décor of a household. Stationary recharge points can be configured to recharge multiple devices seriatim or simultaneously. The perspective drawing of FIG. 9A shows an example scene 900 of a lighting globe 902 configured with a stationary recharge point installed in a room of a home. The lighting globe 902 can function as a decorative IoT light fixture appliance and can also include hardware, such as is described above, configured to direct beams of RF or optical energy to recharge energy-harvesting IoT devices seriatim or substantially simultaneously. In the illustrated scene 900, the energy-harvesting IoT devices include a window blind control 908, a window open or window break sensor 910, a mobile device 912 such as a smartphone or tablet, an indoor security camera 914, a television remote control 916, entertainment system loudspeakers 918, 920, a robotic vacuum cleaner 924, and a flying drone 922. In other examples, different energy-harvesting IoT devices, or more or fewer such devices, can be charged by the energy-transmitting lighting globe 902. For example, the energy-transmitting lighting globe 902 can contain or enclose an RF antenna array or one or more optical beam emitters (e.g., lasers) to produce the energy beams directed to the energy-harvesting IoT devices. In examples in which optical beams are generated, one or more prisms or mirrors can be used to direct the beams. In some examples, actuators of the energy-transmitting lighting globe 902 can adjust the elevation or rotation of the energy-transmitting lighting globe 902, or of an energy transmitter therein, to better aim one or more of the energy beams at one or more energy-harvesting IoT devices to be charged. The energy-harvesting IoT devices to be charged can receive the transmitted energy, and can provide feedback (e.g., via RF communication) to the energy-transmitting lighting globe 902 indicative of their location and/or of the strength of transmitted energy harvested to better direct the energy beams and thus to improve or maximize the amount of energy transmitted to the energy-harvesting IoT devices.

The perspective drawing of FIG. 9B is similar to that of FIG. 9A, except that in the example scene 904, a mirrored ball (disco ball) 906 is the decorative element configured with a stationary recharge point. The mirrors covering the surface of the disco ball can be substantially transparent to the energy transmitted. As with the lighting globe 902 of FIG. 9A, the disco ball 906 of FIG. 9B can include hardware, such as is described above, configured to direct beams of RF or optical energy to recharge energy-harvesting IoT devices seriatim or substantially simultaneously. FIGS. 9A and 9B also show a display or smart TV 926, which can serve as one or both of display device 108 and media device/IoT controller 106 in a media/IoT system 104. For example, various user controls for the IoT system 104 can be accessed via a graphical user interface displayed on the display or smart TV 926, for example, using remote control 916 to navigate IoT system menus and set IoT system options. In some examples, the display or smart TV 926 can include a directed energy transmitter 310 that can be used to charge nearby energy-harvesting IoT devices, such as those shown in the scenes 900, 904, including, for example, the remote control 916. In some examples, the display or smart TV 926 can include a docking station for flying drone 922, to which drone 922 can return for recharging after performing automated directed-energy recharging missions.

Automated roving robots can be configured with directed-energy transmission apparatus to serve as mobile rechargers that can seek out energy-harvesting IoT devices in need of energy recharge and supply them with energy via directed-energy transmission. FIGS. 10A through 10C illustrate an IoT robotic vacuum cleaner 1002 having an optical beam emitter 1004 (e.g., a laser) that can be used to recharge energy-harvesting IoT devices. In some examples, a communication device 314 of the robotic vacuum cleaner 1002 can detect charge-request messages from other energy-harvesting IoT devices that require recharging while the robotic vacuum cleaner 1002 makes its cleaning rounds in a household or business premises. In other examples, the robotic vacuum cleaner 1002 can be ordered to a location of an energy-harvesting IoT device by an IoT controller 114. For example, the robotic vacuum cleaner 1002 can be provided with an approximate or exact location and can use an optimization method with feedback, as described above, to target a directed-energy beam.

Although the illustrated robotic vacuum cleaner 1002 is equipped with an optical energy beam transmitter 1004, in other examples, a robotic vacuum cleaner can be equipped with other directed-energy transmitters, such as an RF energy transmitter. Although the illustrated roving robot is of the form of a robotic vacuum cleaner 1002, in other examples, other automated or remotely-controlled vehicles can be used to convey directed-energy apparatus.

The example robotic vacuum cleaner 1002 can include elevating apparatus to increase effective height of its directed-energy apparatus, such as optical energy beam emitter 1004, as illustrated. The effective height increase can improve the ability to reach the energy-harvesting apparatus, such as photovoltaic cells, of energy-harvesting IoT devices to be charged. The elevating apparatus can include, as examples, a scissors mechanism 1006, as illustrated in FIG. 10B, or a telescoping mechanism 1008, as illustrated in FIG. 10C. A scissors mechanism comprises a set of interconnected linkages arranged in a cross-crossed fashion such that mechanical motion in a first direction that squeezes ends of two linkages together translates into extension of the scissors mechanism in a second direction orthogonal to the first direction. In the illustrated example of FIG. 10B, horizontal translation of the linkage ends at the bottom of the scissors mechanism 1006 translates into vertical extension upwards of the top of the scissors mechanism 1006. A telescoping mechanism comprises a set of substantially concentric parts that extend. A telescoping mechanism can be configured for unidirectional extension or for both extension and contraction. As an example, the telescoping mechanism 1008 can be configured with a spring, and downward force applied by a user can be required to reset (contract) the telescoping mechanism. As another example, air pressure generated by the vacuum motor of the robotic vacuum can be used to increase air pressure inside the telescoping mechanism 1008, causing the telescoping mechanism 1008 to extend, and to contract once the vacuum motor stops pressurizing the inside of the telescoping mechanism.

Flying drones can be configured with directed-energy transmission apparatus to serve as mobile rechargers that can seek out energy-harvesting IoT devices in need of energy recharge and supply them with energy via directed-energy transmission. Flying capabilities for a directed-energy recharger can be particularly advantageous when recharging wireless IoT devices that are located in places that are difficult or dangerous to reach, such as security cameras mounted high on structures or poles. FIGS. 11A and 11B illustrate an IoT flying drone 1102 having directed-energy transmission apparatus (e.g., RF or optical) that can be used to recharge energy-harvesting IoT devices. FIG. 11B is a zoomed-in view of the view of FIG. 11A. In FIGS. 11A and 11B, an outdoor security camera 1106 is mounted under the caves of a roof of a house 1104. In the illustrated example, the outdoor security camera is located in a place where provision of wired AC or DC power and/or solar power may be impracticable.

Accordingly, flying drone 1002 can be used to fly proximate to the security camera 1106 and to transfer energy from the energy storage 308 (e.g., batteries) of the drone 1002 to energy storage 308 of the camera 1106. Although the energy-harvesting IoT device in the illustrated example is a security camera, in other examples, other energy-harvesting IoT devices are possible. Although the example illustrated in FIGS. 11A and 11B involves a flying drone hovering near its energy-transfer target for the duration of the energy-transfer operation, in other examples, the flying drone can land near the target to conduct the energy-transfer operation as a perch-and-stare operation. Although the example illustrated in FIGS. 11A and 11B involves an outdoor charging operation, in other examples, the flying drone can fly indoors to charge indoor IoT devices using its directed-energy apparatus. In some examples, drone perches can be provided near IoT devices to be charged to provide the flying drone 1002 with convenient places to perch during energy-transfer operations. In some examples, a flying drone can be equipped with a clip by which it can attach to a perch for a perch-and-stare energy transfer operation.

In some examples, a broken or missing IoT device can be inferred from the cessation of communication from the IoT device. However, in some instances, cessation of communication may be only indicative of power loss to an IoT device that is otherwise functional and in place. Thus, in some examples, a roving robot used for recharging of IoT devices, such as a robotic vacuum cleaner or flying drone, may observe that a target IoT device is unable to accept directed energy transfer, indicating that the target device is broken, or may observe that the target device is not in place. The roving robot may report the broken or missing status to a media device/IoT controller 106, which can consequently send an alert notification to a user advising the user to repair or replace the missing or broken IoT device. In some examples, a roving robot may observe an IoT device in a location where one is not expected to be, and may report the observation to the media device/IoT controller 106, which can consequently send an alert notification to a user advising the user to investigate in the reported location.

Directed-energy beams may pose risks to human and pet health, particularly at high power. For example, high-power optical beams can be hazardous to eyesight. So as to minimize the risks of health hazards that may be associated with energy beams, in some examples, a media device/IoT controller 106 can delay use of some or all directed-energy recharge methods to a time when a room, home, or business premises is unoccupied by people or pets. In some examples, a media device/IoT controller 106 can permit low-power directed energy transmission under occupied conditions but delay higher-powered directed energy transmission until unoccupied conditions can be assured. In some examples, occupancy can be estimated or determined at least in part by an occupancy schedule, which can be manually set by a user or automatically generated based on IoT sensor inputs.

In some examples, one or more IoT devices can be employed to check for occupancy. For example, one or more motion sensors, active infrared heat sensors, or millimeter wave radar sensors can be used at least in part detect occupancy. As another example, video and/or audio signals from security cameras and/or microphones can be analyzed and used at least in part to test for occupancy. As yet another example, door sensors can be used to determine to within some probability whether an occupant has come or gone. Any of these sensors can be provided as IoT devices within the IoT environment 102. As still another example, recent user or pet manual inputs to IoT devices, the one or more media devices/IoT controllers 106, a display device 108, or a remote control 110 can be counted as signs of occupancy. For example, a user change of a TV channel via a local remote control can be an indicator of occupancy.

As another example, a location of an occupant's mobile device (e.g., smartphone), as may be determined from GPS of the mobile device can be queried to ascertain the probable location of an occupant as being outside of the room, home, or business premises. As still another example, an alert notification with a confirmation control (e.g., confirmation button) can be sent to a mobile device, and directed-energy recharge activity can be forestalled until unoccupancy has been confirmed via the confirmation control. Signals from multiple forms of sensors, such as those mentioned above, can be combined to enhance the occupancy probability determination. For example, a machine learning model (e.g., an artificial neural network) or Kalman filter can be used to merge sensor inputs and produce an output of unoccupancy probability. An IoT system 104 can be configured to permit directed-energy charging of IoT devices only when a determined unoccupancy probability exceeds a threshold, and to quickly halt directed-energy charging, or reduce power of directed-energy charging, when occupancy is detected by one or more triggers.

### Manual Recharging of Energy-Harvesting IoT Devices

Alternatively or in addition to the automatic recharging of energy-harvesting IoT devices via stationary recharge points or mobile robots, some example IoT environments may provide for rapid, energy-harvesting-based manual recharging of IoT devices using a directed energy recharger. The directed-energy recharger can be stationary or user-carried. The stationary directed-energy recharger can be any of the stationary recharge points discussed above. As an example, a media device/IoT controller 106 can send an alert to a user that an IoT window sensor is low on energy, prompting the energy to remove the window sensor from the window and hold or place the window sensor near a stationary recharge point for charging. After charging is complete, the user can place the window sensor back on the window. The window sensor can be conveniently detachably attached to the window for repeated removal and replacement (e.g., using a hook-and-loop fastener). In some examples, the stationary recharge point can be a display device 108, media device/IoT controller 106, or combination thereof (e.g., smart TV).

A user-carried directed energy recharger can be a portable device equipped with apparatus for directed energy transfer, e.g., equipped with an RF or optical energy transmitter. As an example, the directed energy recharger can be integrated in a remote control for a television or other media device. In such an example, a signal output device of the remote control, such as an infrared LED, can serve the additional purpose of acting as an emitter for power delivery to an energy-harvesting IoT device (a target device). A directed energy recharger (e.g., remote control) can be configured to be carried by a user in or around a household or business premises to manually recharge target devices, including sensors, actuators, and repeaters. For example, the directed energy recharger can be carried by a user to a location proximate to an IoT device in need of recharge (target device), where the user can point the directed energy recharger at the target device, and activate recharging, e.g., by depressing or holding down a button on the directed energy recharger to transmit energy to the target device. Energy harvesting apparatus of the target device can then transduce the transmitted energy to electrical energy to recharge energy storage 308 of the target device.

In some examples, a user can be notified of the need to manually recharge an energy-harvesting IoT device via an alert displayed on a user device, such as a television or personal computer display or mobile device (e.g., smartphone). Such alerts can be prompted by a communication message from an IoT device indicating an “energy storage low” status, or based on scheduling or a predictive model that can predict when an IoT device may be in need of recharging. As an example, the scheduling or predictive model can be managed and executed using a media device/IoT controller 106 in a media/IoT system 104 of the multimedia/IoT environment 102 of FIG. 1.

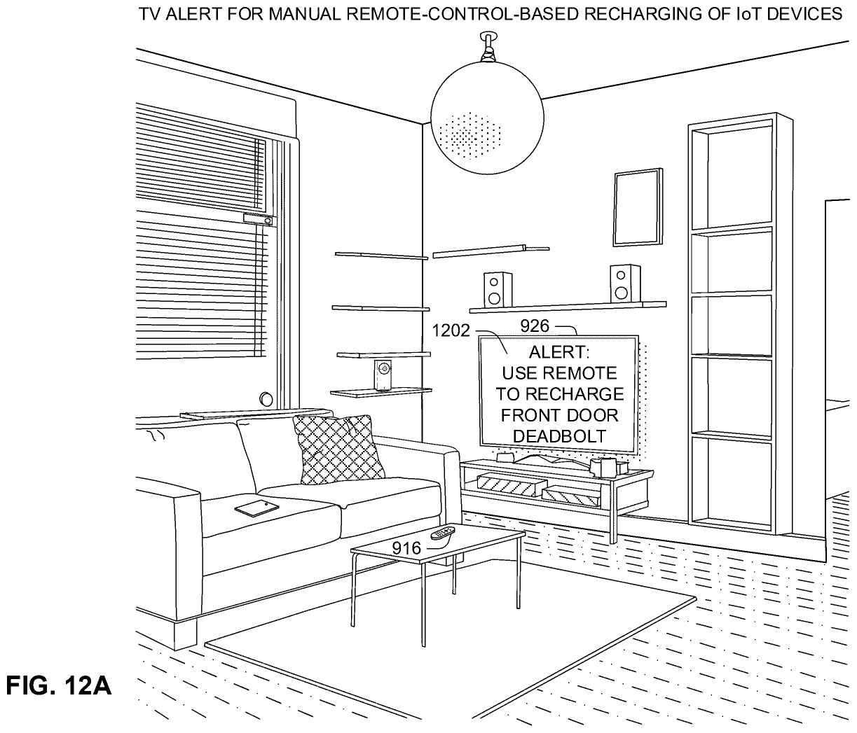

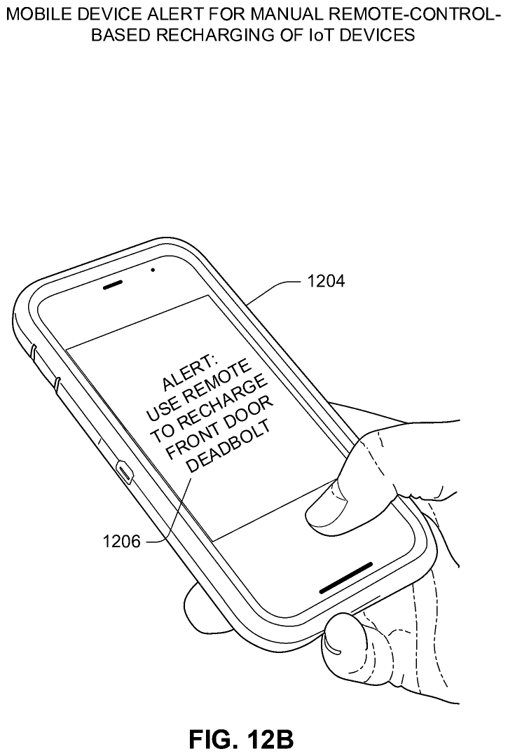

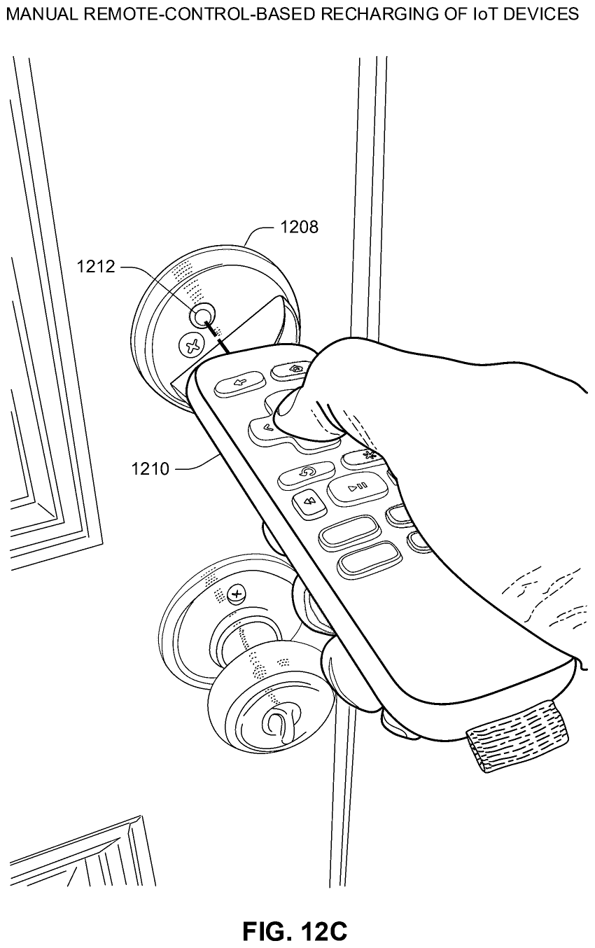

FIGS. 12A and 12B illustrate example presentations of alerts to user devices by a media/IoT system 104. In the example shown in FIG. 12A, a media/IoT system 104 presents an alert message 1202 on a display of television 926, which can correspond to display device 108 of FIG. 1. The alert message 1202 can contain text worded to remind or prompt a user to manually use a directed energy recharger, such as remote control 916, to recharge an energy-harvesting IoT device in the multimedia/IoT environment 102. In the illustrated example, the alert message generated and displayed by the media/IoT system 104 is worded to remind or prompt a user to recharge an IoT door deadbolt, but in other examples, the user may be reminded or prompted to recharge additional, or one or more different, IoT devices. The media/IoT system 104 may additionally or alternatively send an alert message to a user's mobile device. In the example shown in FIG. 12B, a media/IoT system 104 presents a similar alert 1206 on a display of a smartphone 1204 of the user.

FIG. 12C illustrates use of a user-carried directed energy recharger to manually recharge an energy-harvesting IoT device in need of energy recharging (target device). In the illustrated example, the directed energy recharger is a TV or media device remote control 1210, and the target device is an IoT deadbolt 1208 for a door, but in other examples, the directed energy recharger can take different forms, and/or the target device can be other IoT devices. In the illustrated example, the remote control 1210 is configured such that a user can point the remote control 1210 at an energy-harvesting transducer 1212 of the deadbolt 1208 and can press and hold a directed energy transmission activation button of the remote control 1210 to transmit energy, such as infrared optical energy, to the energy-harvesting transducer 1212 of the deadbolt 1208.

One or more devices of the multimedia/IoT environment 102 can notify the user of a sufficient or full charge, thus prompting the user to discontinue manual recharging, in any one or more of a number of ways. As one example, the deadbolt 1208 (or other target device) can be configured with a small speaker or LED (not shown) by which the deadbolt 1208 (or other target device) can sound or show an audible or visible alert, such as a chime sound, or the LED coming on or changing color (e.g., from red, to indicate charging, to green, to indicate full charge). As another example, the remote control 1210 (or other directed energy recharger) can be configured with a small speaker or LED by which it can sound or show an audible or visible alert, such as a chime sound, or the LED coming on or changing color. For such purpose, the remote control 1210 (or other directed energy recharger) can be made aware of the target device's charging/charged status via communication, e.g., RF communication, from the target device, either directly or via a network 118. As yet another example, an alert can be sounded or displayed via one or more devices that originally prompted the user to recharge the target device, such as the television display 926 in FIG. 12A or the smartphone 1204 in FIG. 12B.

In other examples, IoT devices can be configured with one or more replaceable batteries. A media device/IoT controller 106 can determine or predict that an IoT device needs battery replacement and can transmit an alert message to remind or prompt a user to make the needed battery replacement. The battery replacement alert message can be displayed to the user in any of the ways described above. Any of the alert messages generated for users can additionally or alternatively be played audibly over speakers, such as a speaker of an IoT device or of a display device 108.

### App for IoT Environment Setup and Maintenance

A media device/IoT controller 106 or associated device (e.g., a mobile device registered to the media/IoT system 104) can execute a smart home network application (“app”) for setup and/or maintenance of the multimedia/IoT environment 102. As examples, the app can be configured to inform IoT device placement during setup and can promote, within the multimedia/IoT environment 102, spatial awareness and network power status understanding for reactive, preemptive, or predictive charging. As examples, the app can track or predict energy charge and health statuses of IoT devices within the multimedia/IoT environment 102, can schedule or predict desired recharge times to maintain sufficient energy charge of IoT devices, can perform subsequent automated IoT device energy management direction (e.g., by activating energy transmitters of stationary recharge points and/or commanding mobile recharging robots to go recharge IoT devices), and/or can remind or prompt one or more users 132 to manually recharge devices via alert notifications, as described above with regard to FIGS. 12A through 12C.

A media device/IoT controller 106 can use spatial awareness of the physical layout of the multimedia/IoT environment 102 and absolute or relative IoT device positioning therein for a number of functions. As one example, during an initial setup of the IoT environment 102 or subsequent installation operation of the IoT environment 102, when a user is placing IoT devices throughout a home or business premises, a media device/IoT controller 106 (or associated device) may advise device placement based on its understanding of the environment physical layout and its understanding of the power consumption properties, energy harvesting abilities, and/or maximum or recommended low-power-consumption communication transmission distances of one or more of the IoT devices.

As another example, when presenting an IoT device health status or recharge request alert notification to a user, the media device/IoT controller 106 (or associated device) can use spatial awareness of the physical layout to present to the user a layout map of the multimedia/IoT environment 102 with the location(s) of one or more IoT devices referenced in the notification indicated on the layout map, advantageously promoting the user's understanding of which IoT device or devices are in need of recharging, repositioning, replacement, or repair.

As still another example, a media device/IoT controller 106 can use spatial awareness of the physical layout of the multimedia/IoT environment 102 to direct stationary recharge points to recharge energy-harvesting IoT devices that are in proximity to the stationary recharge points and are positioned to receive directed energy from the stationary recharge points.

As yet another example, when commanding a mobile recharging robot, such as robotic vacuum 1002 in FIG. 10A or flying drone 1102 in FIG. 11B, to go and recharge one or more other energy-harvesting IoT devices (target devices), a media device/IoT controller 106 can advantageously provide the mobile recharging robot with the location(s) of the target device(s) to guide the navigation of the robot.

The spatial awareness of the physical layout of the IoT environment 102 can take a number of forms and can be provided to or determined by the media device/IoT controller 106 in a number of ways. In some examples, spatial awareness data is two-dimensional (“2D”) data indicating (X, Y) coordinate values or extents of IoT devices, walls, doors, windows, and/or other spatial features within a plane, with respect to an arbitrary but consistent origin point (0, 0). In such examples, the spatial awareness data can include a partial or complete floor plan of the home or business premises of the IoT environment 102. In some examples, the spatial awareness data is multiplanar two-dimensional (“2.5D”) data indicating (X, Y, Z) coordinate values or extents of IoT devices, walls, doors, windows, and/or other spatial features within multiple planes that can correspond, for example, to multiple floors of the home or business premises, with the Z coordinate values quantized to the individual planes (e.g., 1 for first floor, 2 for second floor, etc.). In such examples, the spatial awareness data can include multiple partial or complete floor plans. In some examples, the spatial awareness data is three-dimensional (“3D”) data with indicating (X, Y, Z) coordinate values or extents of IoT devices, walls, doors, windows, and/or other spatial features. In such examples, the spatial awareness data can include a partial or complete 3D model of the home or business premises.

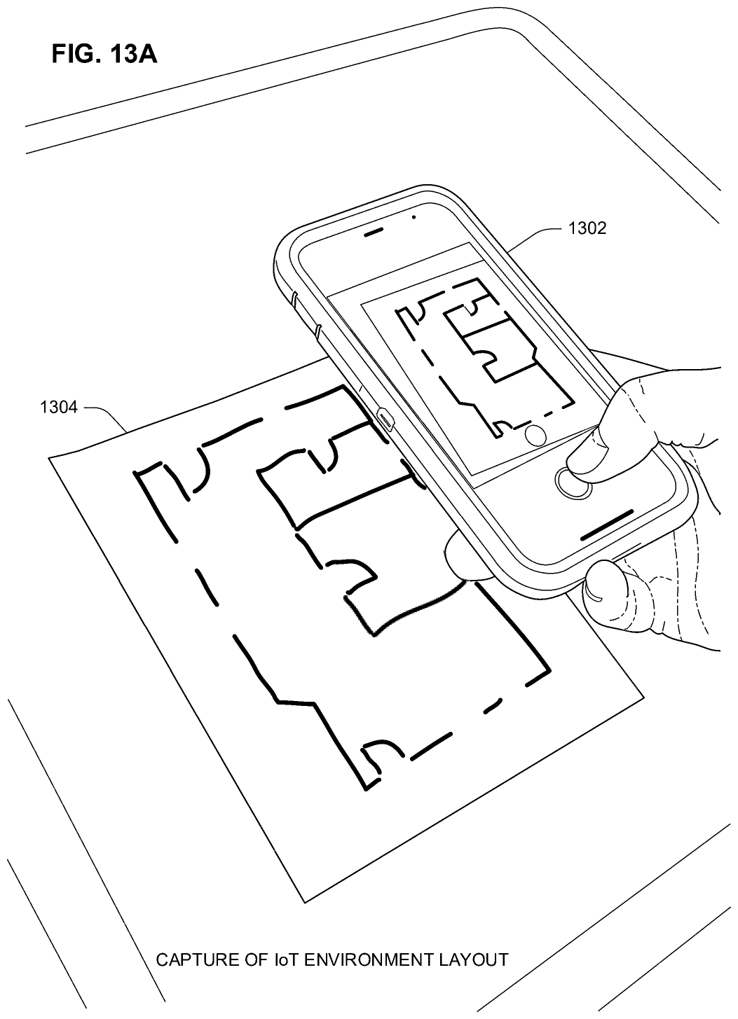

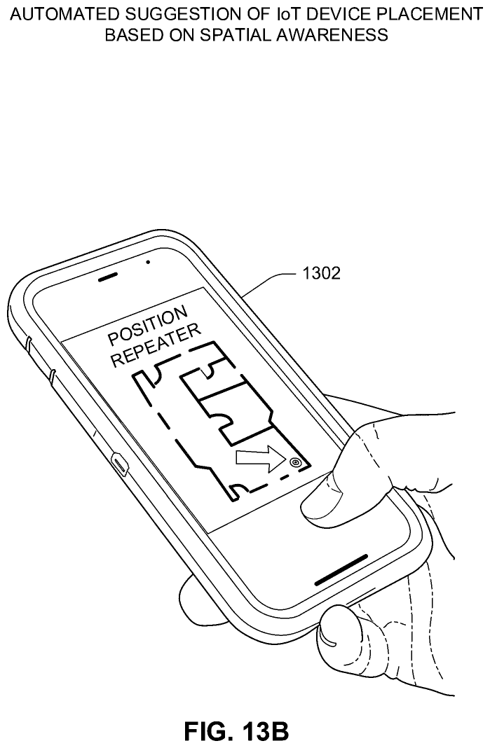

In some examples, spatial awareness data can be supplied to a media device/IoT controller 106 by a user. For example, a user may provide one or more floor plans to the media device/IoT controller 106, e.g., by uploading raster or vector images using a floor plan upload tool of the IoT app, by drawing an image using a floor plan drawing tool of the IoT app, or by acquiring a camera image of a floor plan to the IoT app. The example of FIG. 13A shows a mobile device 1302 configured to acquire floor plan data via a camera of the mobile device 1302. For example, the mobile device 1302 can execute a mobile device app configured for acquiring spatial awareness data. In the illustrated example, the mobile device 1302 is configured to be commanded by a user to take a digital photograph of a drawing or sketch 1304 having floor plan data. The digital photograph is interpreted by the IoT app or a cloud-based service associated therewith to generate spatial awareness data of the IoT environment 102. As an example, the IoT app or cloud-based service can use a machine learning model to convert the digital photograph to (X, Y) feature data that can approximate a home or business premises layout or layout portion. The (X, Y) feature data can be refined, augmented, or supplemented through additional user inputs that may be prompted by the mobile device app or IoT app, such as user-input measurements. In other examples, photographs of indoor features may be analyzed by the mobile device app or IoT app using automated photogrammetry to derive spatial awareness data.

In some examples, spatial awareness data can be automatically acquired by a media device/IoT controller 106. In some example, the automatically acquired spatial awareness data can be derived via communications with one or more IoT devices in the multimedia/IoT environment that can reveal relative range and direction information between transmitters and receivers of different devices. For example, the directed RF transmission method of FIG. 4 may determine relative direction information between an energy-transmitting IoT device and a target device, which information can be reported to the media device/IoT controller 106 and used to inform the spatial awareness of the media/IoT system 104. Spatial information determined by automated roving robots of the IoT environment 102 can similarly be reported to the media device/IoT controller 106 and used to inform the spatial awareness of the media/IoT system 104. As one example, as a robotic vacuum cleaner bumps into walls and obstacles during its cleaning rounds, it can effectively map spaces and can store and report map data. As another example, as a robotic flying drone navigates an indoor or outdoor space, it may derive ranging data or photographic data that can be reported to the media device/IoT controller 106 and used to inform the spatial awareness of the IoT environment 102.

As described above with regard to IoT devices 132, 134, 136 of FIG. 1, some IoT devices may be configured to operate using relatively low energy expenditure budgets and consequently may be configured to only expend enough power transmitting RF communication messages to a next nearest IoT device rather than to a more distant network device such as a Wi-Fi router. The next nearest IoT device can then serve as a repeater to forward the received messages on to the media device/IoT controller 106 of the system 104, e.g., via a network 118. During or subsequent to an initial setup of an IoT environment 102, a user may engage in IoT device placement, e.g., based in part on advice supplied by an IoT controller 106 or associated device. The IoT controller 106 or associated device can determine a need for repeater IoT device placement and direct a user to place one or more IoT devices as repeaters in certain locations within or around a home or business premises so as to better ensure receipt of messages from one or more low energy expenditure budget IoT devices. Placement advice or direction may also be for other types of IoT devices, such as various sensors or actuators. Such placement advice or direction can be based on the spatial awareness data known to the IoT controller 106.

As one example, FIG. 13B shows a mobile device 1302 directing a user to position an IoT device as a repeater at a location on a floor plan of the IoT environment 102. In some examples, the suggested device placement can be based in part on a failure to receive IoT communications by the IoT controller 106 from a low energy expenditure budget IoT device. In some examples, the media device/IoT controller 106 or associated device (e.g., mobile device, such as mobile device 1302) can, upon placement of the repeater or other IoT device, transmit a notification to the user (e.g., via the mobile device) indicating that the suggested IoT device placement was successful or, on the contrary, unsuccessful, and suggesting an adjustment or repeat attempt at user placement of the IoT device.

In some examples, a mobile device (e.g., smartphone) used to run an IoT environment setup app may make use of an attached peripheral communications device, such as a universal serial bus (USB) dongle, to receive communication signals from the IoT devices, as may be useful during placement. The peripheral device may be necessary as when the IoT devices are not configured to communicate using a protocol recognizable by the mobile device. In some examples, the IoT devices may be configured to communicate using Bluetooth or another protocol receivable by the mobile device.

A media device/IoT controller 106 can combine spatial awareness data from different sources to generate a refined spatial awareness understanding. For example, one or more machine learning models can be trained with spatial awareness data from different sources, such as the user sources and IoT device sources described above. The training data can also include refined spatial models and/or measurements as intended outputs of the trained one or more machine learning models. So trained, the one or more machine learning models can be provided in a media device/IoT controller 106, or as a module of a system server 126 accessible by a media device/IoT controller 106 (“on the cloud”), for inferencing based on spatial awareness data supplied by one or more users and/or one or more IoT devices. As an example, a machine learning model can be trained to combine one or more floor plans (e.g., derived from photographs or uploaded drawings), one or more inter-device relative direction vectors (e.g., as determined from one or more RF energy transmission processes such as method 400 in FIG. 4), and one or more obstacle maps from a roving robotic IoT device to output an enhanced spatial map of the IoT environment based on the multiple types of spatial awareness data input.

In some examples, an IoT app or mobile device app can be configured to evaluate and approve or disapprove user-proposed IoT device placement locations prior to placement. For example, a media device/IoT controller 106 or associated device (e.g., smartphone) may provide a screen by which a user can input a proposed IoT device location, such as a sensor. The media device/IoT controller 106 or associated device can then evaluate the placement, based on the type of IoT device proposed to be placed, its power requirements, and spatial awareness data known to the media device/IoT controller 106. In some examples, the media device/IoT controller 106 may suggest that the placement is unsuitable. Placement may be unsuitable for a variety of reasons, such as excessive distance from a transmitted energy source or source of harvested energy (e.g., sunlight), poor incidence of angle from a transmitted energy source or source of harvested energy, excessive distance from a node of the communications network 118 or another IoT device configured as a repeater, excessive distance from an actuation target of the IoT device, interference with optical energy transmission from obstacles, or other reasons. In some examples, upon determination of unsuitability of a user-proposed IoT device placement, the media device/IoT controller 106 may suggest a different placement for the IoT device, or may suggest placement of one or more other IoT devices to act as one or more communications signal repeaters and/or one or more stationary recharge points.

In some embodiments, a media device/IoT controller 106 or associated device (e.g., a mobile device registered to the media/IoT system 104) can execute an IoT environment status app to track or predict energy charge and health statuses of IoT devices within the multimedia/IoT environment 102. As one example, an IoT controller 106 can be store default health or charge profiles of a variety of different kinds of IoT devices and can base recharge or replacement suggestions or commands at least in part on the stored profiles. As another example, an IoT controller 106 can receive periodic IoT device health status messages or storage charge status messages from various IoT devices within the IoT environment 102. The IoT controller 106 can track and store data from the device health status messages or storage charge status messages over time and can perform regression analysis on the stored data, or analysis using one or more trained machine learning models, to generate profiles (or to modify the default profiles) that provide understandings of how long an IoT device may have until it will require recharging (e.g., via a manual or automated method as described above) or how long an IoT device may have until its energy storage 308 (e.g., a rechargeable battery) or the entire IoT device may need replacement. As yet another example, the IoT controller 106 can infer IoT device energy charge loss or misplacement based on failure to receive health status messages or storage charge status messages from one or more IoT devices. For example, if the IoT controller 106 has not received a report from an IoT device for more than a threshold time (e.g., one minute, one hour, or one day), then the IoT controller 106 can consider the non-reporting IoT device to be energy-exhausted and suggest or command a recharge.

In some embodiments, a media device/IoT controller 106 can compile, store, and display to a user default or generated health and/or energy profiles, and/or times to next charge, for various IoT devices, e.g., via a display device 108 or mobile device of the user. In some embodiments, the media device/IoT controller 106 can generate IoT device recharging schedules based on stored energy profiles and/or based on user-input or generated home or business premises occupancy schedules. The media device/IoT controller 106 can base commands to one or more stationary recharge points and/or one or more mobile recharging robots on generated recharge schedules.

As an example, a media device/IoT controller 106 may determine, based on a default or compiled charge profile of an IoT device, that the IoT device will need recharging before 9:00 PM. However, the media device/IoT controller 106 may also understand, based on an occupancy schedule, that the home or business premises will be occupied by people or pets between 4:00 PM and 9:00 PM, and thus that no automated directed-energy recharge should be scheduled during this time period. Based on this information, the media device/IoT controller 106 can scheduling a recharge of the IoT device before 4:00 PM, even though it will not run out of energy until later in the night.

As another example, a media device/IoT controller 106 may determine, based on default or compiled charge profiles and based on spatial awareness data, that two IoT cameras will both need recharging by a flying drone and that both will run out of power at 2:00 AM. However, the media device/IoT controller 106 may understand that only one flying drone is available within the IoT environment 102, that this drone will take one half hour to charge one of the cameras, and that the drone will itself require one hour of recharging between recharging each of the two IoT cameras. Based on this information, the media device/IoT controller 106 can scheduling a recharge of one IoT camera before midnight, even though it will not run out of energy until several hours later, to allow sufficient time for the drone to recharge and service the other IoT camera.

In some embodiments, a media device/IoT controller 106 may determine, based on one or more messages from an IoT device and/or based on a default or compiled health profile for the IoT device, that an IoT device or its energy storage 308 (e.g., battery) is in need of replacement, and may automatically place an order over the internet for a replacement IoT device or battery with a vendor. In some examples, the media device/IoT controller 106 may request and receive user consent prior to placing the order, e.g., by first sending an alert notification to a user device and receiving a reply signal indicating user feedback approving the replacement order. As an example, a media device/IoT controller 106 can detect that a ten-year lifetime of a basement IoT carbon monoxide detector has expired, and can automatically place an order for a replacement carbon monoxide detector. The media device/IoT controller 106 can send an alert notification to the user with instructions on how to replace the IoT carbon monoxide detector that may include a pictorial representation of the carbon monoxide detector's location within the home or business premises.

### Example Computer-Implemented Method

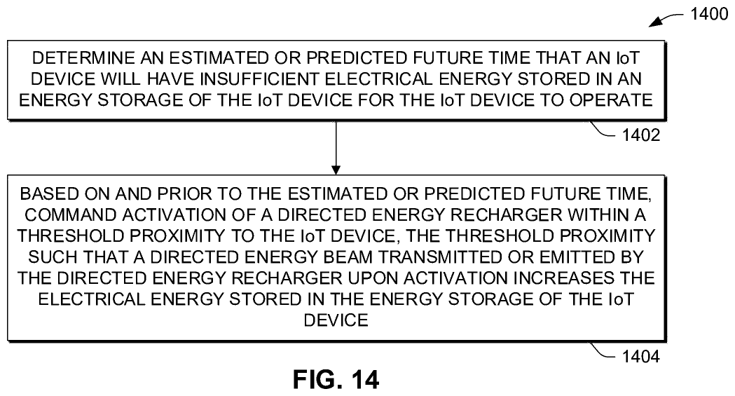

FIG. 14 illustrates an example computer-implemented method 1400 for automated recharging of an IoT device. The IoT device can be, for example, any of the energy-harvesting IoT devices described above, or some combination thereof. In some examples, the IoT device is a device that includes an energy storage, an RF communication transmitter, and an energy harvester. In some examples, the IoT device is not coupled to an electrical power distribution system to receive power from the electrical power distribution system in a way capable of recharging the energy storage of the device. The method 1400 can be implemented on a computer processor, such as the processor 1504 of the computer system 1500 of FIG. 15 (as described below). In some examples, the processor can be a processor of a media device/IoT controller 106 as shown in FIG. 1.

The method 1400 can include determining 1402 an estimated or predicted future time that the IoT device will have insufficient electrical energy stored in an energy storage of the IoT device for the IoT device to operate. In the context of method 1400, operation of the IoT device means at least transmission of RF communication messages by and from the IoT device and performance of at least one other task for which the IoT device is configured, e.g., as a sensor, communications signal repeater, actuator, energy transmitter, user interface element, or some combination thereof. Thus, if the IoT device is configured as a sensor, but does not have sufficient power to sense the signal or parameter that it is configured to sense, then the IoT device is not operational within the context of method 1400. An IoT device is not considered operational within the context of method 1400 merely by the IoT device's receptivity to transmitted energy (e.g., operation of energy harvesting apparatus of the IoT device).

Method 1400 can continue with commanding 1404 activation of a directed energy recharger. The commanding 1404 can be based on and prior to the estimated or predicted future time. At the time of the activation, the directed energy recharger is within a threshold proximity to the device. The threshold proximity is such that a directed energy beam transmitted or emitted by the directed energy recharger upon activation increases the energy stored in the energy storage of the IoT device. As an example, the commanding can be performed by the processor directing an RF communication message to be sent to the directed energy recharger, as in examples when the directed energy recharger is implemented in a separate physical device or module from the processor. The RF communication message, received and interpreted by the directed energy recharger, subsequently causes the directed energy recharger to activate its directed energy beam, either immediately or at some later time. In examples in which the directed energy recharger is implemented in the same device or module as the processor, the commanding can be performed by the processor directing an electrical signal along an electrically conductive line that activates the directed energy beam.

The distance value of the threshold proximity may depend on various factors, including the power strength of the directed energy beam, the presence of any obstacles between or around the directed energy recharger and the IoT device that may reduce the power from the directed energy beam as received by the IoT device, and electromagnetic interference that may be present at the time of the transmission or emission of the directed energy beam. In some examples, a media device/IoT controller 106 may calculate the threshold proximity, for example, based on spatial awareness data, power delivery capabilities of one or more directed energy rechargers (e.g., stationary recharge points or roving robots), real-time or historical feedback from one or more IoT devices presently being charged or charged in the past, and/or other factors. The directed energy recharger need not be within the threshold proximity at the time of the commanding 1404. The directed energy recharger need only be within the threshold proximity at a later time when the directed energy recharger, responsive to the command, transmits or emits a directed energy beam to recharge the device. For example the commanding 1404 may be to a roving robot implemented as a directed energy recharger, such as robotic vacuum cleaner 1002 or flying drone 1102, that is initially outside of the threshold proximity, but that comes within the threshold proximity after traveling to the IoT device to be recharged. Thus, the commanding 1404 may include an implicit or explicit instruction for the directed energy recharger to reposition itself to within the threshold proximity.

### Example Computer System

Various embodiments may be implemented, for example, using one or more well-known computer systems, such as computer system 1500 shown in FIG. 15. For example, the media device/IoT controller 106 may be implemented using combinations or sub-combinations of computer system 1500. Also or alternatively, one or more computer systems 1500 may be used, for example, to implement any of the embodiments discussed herein, as well as combinations and sub-combinations thereof.

Computer system 1500 may include one or more processors (also called central processing units, or CPUs), such as a processor 1504. Processor 1504 may be connected to a communication infrastructure or bus 1506.

Computer system 1500 may also include user input/output device(s) 1503, such as monitors, keyboards, pointing devices, etc., which may communicate with communication infrastructure 1506 through user input/output interface(s) 1502.

One or more of processors 1504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1500 may also include a main or primary memory 1508, such as random access memory (RAM). Main memory 1508 may include one or more levels of cache. Main memory 1508 may have stored therein control logic (i.e., computer software) and/or data.

Computer system 1500 may also include one or more secondary storage devices or memory 1510. Secondary memory 1510 may include, for example, a hard disk drive 1512 and/or a removable storage device or drive 1514. Removable storage drive 1514 may be a floppy disk drive, a magnetic tape drive, a compact disk drive, an optical storage device, tape backup device, and/or any other storage device/drive.

Removable storage drive 1514 may interact with a removable storage unit 1518. Removable storage unit 1518 may include a computer usable or readable storage device having stored thereon computer software (control logic) and/or data. Removable storage unit 1518 may be a floppy disk, magnetic tape, compact disk, DVD, optical storage disk, and any other computer data storage device. Removable storage drive 1514 may read from and/or write to removable storage unit 1518.

Secondary memory 1510 may include other means, devices, components, instrumentalities or other approaches for allowing computer programs and/or other instructions and/or data to be accessed by computer system 1500. Such means, devices, components, instrumentalities or other approaches may include, for example, a removable storage unit 1522 and an interface 1520. Examples of the removable storage unit 1522 and the interface 1520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1500 may further include a communication or network interface 1524. Communication interface 1524 may enable computer system 1500 to communicate and interact with any combination of external devices, external networks, external entities, etc. (individually and collectively referenced by reference number 1528). For example, communication interface 1524 may allow computer system 1500 to communicate with external or remote devices 1528 over communications path 1526, which may be wired and/or wireless (or a combination thereof), and which may include any combination of LAN, WANs, the Internet, etc. Control logic and/or data may be transmitted to and from computer system 1500 via communication path 1526.

Computer system 1500 may also be any of a personal digital assistant (PDA), desktop workstation, laptop or notebook computer, netbook, tablet, smartphone, smart watch or other wearable, appliance, part of the Internet-of-Things, and/or embedded system, to name a few non-limiting examples, or any combination thereof.

Computer system 1500 may be a client or server, accessing or hosting any applications and/or data through any delivery paradigm, including but not limited to remote or distributed cloud computing solutions; local or on-premises software (“on-premises” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1500, main memory 1508, secondary memory 1510, and removable storage units 1518 and 1522, as well as tangible articles of manufacture embodying any combination of the foregoing. Such control logic, when executed by one or more data processing devices (such as computer system 1500 or processor(s) 1504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 15. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example,” “an example embodiment,” or similar phrases, indicate that the example or embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for automated recharging of a radio-frequency (RF) communication-enabled device not coupled to an electrical power distribution system, the method comprising:
determining, by at least one computer processor, an estimated or predicted future time that a device will have insufficient electrical energy stored in an energy storage of the device for the device to operate, wherein the device comprises an RF communication transmitter and an energy harvester, and wherein the device is not coupled to an electrical power distribution system to receive power from the electrical power distribution system in a way capable of recharging the energy storage of the device; and
based on and prior to the estimated or predicted future time, commanding activation of a directed energy recharger within a threshold proximity to the device, the threshold proximity such that a directed energy beam transmitted or emitted by the directed energy recharger upon activation increases the electrical energy stored in the energy storage of the device.

2. The method of claim 1, wherein the directed energy recharger comprises RF antennas arranged as a phased array antenna system, the directed energy beam is an RF energy beam formed using the phased array antenna system, and the method further comprises:
transmitting a request RF communication message to the device;
receiving a reply RF communication message from the device responsive to the request RF communication message;
determining a first time of flight of the reply RF communication message from the device to a first antenna of the RF antennas of the directed energy recharger;
determining a second time of flight of the reply RF communication message from the device to a second antenna of the RF antennas of the directed energy recharger; and
determining a direction of the RF energy beam based on the first time of flight and the second time of flight.

3. The method of claim 1, wherein the directed energy recharger comprises an optical beam emitter, the directed energy beam is an optical beam formed using the optical beam emitter, and the method further comprises:
actuating a direction of the optical beam in a search pattern;
during the actuating the direction of the optical beam, receiving feedback RF communication messages from the device indicative of a strength of optical energy received by the device via the optical beam; and
actuating the direction of the optical beam based on the feedback RF communication messages.

4. The method of claim 1, wherein the directed energy recharger comprises an optical beam emitter, the directed energy beam is an optical beam formed using the optical beam emitter, the directed energy recharger further comprises an optical sensor configured to sense a retroreflection of the optical beam from the device, and the method further comprises the directed energy recharger:
actuating a direction of the optical beam in a search pattern;
during the actuating the direction of the optical beam, sensing a feedback signal from the optical sensor; and
actuating the direction of the optical beam based on the feedback signal from the optical sensor.

5. The method of claim 1, further comprising:
determining that a human or pet is in a vicinity of the directed energy beam based on a human or pet manual input or based on an output of a sensor configured to detect human or pet occupancy; and
commanding a reduction in power of the directed energy beam based on the determination that the human or pet is in the vicinity of the directed energy beam.

6. The method of claim 1, wherein the directed energy recharger comprises an RF communication receiver, and the commanding the activation of the directed energy recharger comprises transmitting an RF communication message to the directed energy recharger.

7. The method of claim 1, wherein the directed energy recharger comprises a device selected from the group consisting of a lighting fixture, a mirrored ball, a robotic vacuum cleaner, a flying drone, a wall-mounted AC electrical outlet, a wall-mounted light switch, and a smart TV that comprises the at least one computer processor.

8. A system, comprising:
one or more memories; and
at least one processor coupled to at least one of the one or more memories and configured to perform operations comprising:
determining an estimated or predicted future time that a device will have insufficient electrical energy stored in an energy storage of the device for the device to operate, wherein the device comprises a radio-frequency (RF) communication transmitter and an energy harvester, and wherein the device is not coupled to an electrical power distribution system to receive power from the electrical power distribution system in a way capable of recharging the energy storage of the device; and
based on and prior to the estimated or predicted future time, commanding activation of a directed energy recharger within a threshold proximity to the device, the threshold proximity such that a directed energy beam transmitted or emitted by the directed energy recharger upon activation increases the electrical energy stored in the energy storage of the device.

9. The system of claim 8, wherein the directed energy recharger comprises RF antennas arranged as a phased array antenna system, the directed energy beam is an RF energy beam formed using the phased array antenna system, and wherein the operations further comprise:
transmitting a request RF communication message to the device;
receiving a reply RF communication message from the device responsive to the request RF communication message;
determining a first time of flight of the reply RF communication message from the device to a first antenna of the RF antennas of the directed energy recharger;
determining a second time of flight of the reply RF communication message from the device to a second antenna of the RF antennas of the directed energy recharger; and
determining a direction of the RF energy beam based on the first time of flight and the second time of flight.

10. The system of claim 8, wherein the directed energy recharger comprises an optical beam emitter, the directed energy beam is an optical beam formed using the optical beam emitter, and the operations further comprise:
actuating a direction of the optical beam in a search pattern;
during the actuating the direction of the optical beam, receiving feedback RF communication messages from the device indicative of a strength of optical energy received by the device via the optical beam; and
actuating the direction of the optical beam based on the feedback RF communication messages.

11. The system of claim 8, wherein the directed energy recharger comprises an optical beam emitter, the directed energy beam is an optical beam formed using the optical beam emitter, the directed energy recharger further comprises an optical sensor configured to sense a retroreflection of the optical beam from the device, and the directed energy recharger is configured to:
actuate a direction of the optical beam in a search pattern;
during the actuating the direction of the optical beam, sense a feedback signal from the optical sensor; and
actuate the direction of the optical beam based on the feedback signal from the optical sensor.

12. The system of claim 8, wherein the operations further comprise:
determining that a human or pet is in a vicinity of the directed energy beam based on a human or pet manual input or based on an output of a sensor configured to detect human or pet occupancy; and
commanding a reduction in power of the directed energy beam based on the determination that a human or pet is in the vicinity of the directed energy beam.

13. The system of claim 8, wherein the directed energy recharger comprises an RF communication receiver, and the commanding the activation of the directed energy recharger comprises transmitting an RF communication message to the directed energy recharger.

14. The system of claim 8, wherein the directed energy recharger comprises a device selected from the group consisting of a lighting fixture, a mirrored ball, a robotic vacuum cleaner, a flying drone, a wall-mounted AC electrical outlet, a wall-mounted light switch, and a smart TV that comprises the at least one processor.

15. A non-transitory computer-readable medium having instructions stored thereon that, when executed by at least one computing device, cause the at least one computing device to perform operations comprising:
determining an estimated or predicted future time that a device will have insufficient electrical energy stored in an energy storage of the device for the device to operate, wherein the device comprises a radio-frequency (RF) communication transmitter and an energy harvester, and wherein the device is not coupled to an electrical power distribution system to receive power from the electrical power distribution system in a way capable of recharging the energy storage of the device; and
based on and prior to the estimated or predicted future time, commanding activation of a directed energy recharger within a threshold proximity to the device, the threshold proximity such that a directed energy beam transmitted or emitted by the directed energy recharger upon activation increases the electrical energy stored in the energy storage of the device.

16. The computer-readable medium of claim 15, wherein the directed energy recharger comprises RF antennas arranged as a phased array antenna system, the directed energy beam is an RF energy beam formed using the phased array antenna system, and wherein the operations further comprise:
transmitting a request RF communication message to the device;
receiving a reply RF communication message from the device responsive to the request RF communication message;
determining a first time of flight of the reply RF communication message from the device to a first antenna of the RF antennas of the directed energy recharger;
determining a second time of flight of the reply RF communication message from the device to a second antenna of the RF antennas of the directed energy recharger; and
determining a direction of the RF energy beam based on the first time of flight and the second time of flight.

17. The computer-readable medium of claim 15, wherein the directed energy recharger comprises an optical beam emitter, the directed energy beam is an optical beam formed using the optical beam emitter, and the operations further comprise:
actuating a direction of the optical beam in a search pattern;
during the actuating the direction of the optical beam, receiving feedback RF communication messages from the device indicative of a strength of optical energy received by the device via the optical beam; and
actuating the direction of the optical beam based on the feedback RF communication messages.

18. The computer-readable medium of claim 15, wherein the directed energy recharger comprises an optical beam emitter, the directed energy beam is an optical beam formed using the optical beam emitter, the directed energy recharger further comprises an optical sensor configured to sense a retroreflection of the optical beam from the device, and the directed energy recharger is configured to:
actuate a direction of the optical beam in a search pattern;
during the actuating the direction of the optical beam, sense a feedback signal from the optical sensor; and
actuate the direction of the optical beam based on the feedback signal from the optical sensor.

19. The computer-readable medium of claim 15, wherein the operations further comprise:
determining that a human or pet is in a vicinity of the directed energy beam based on a human or pet manual input or based on an output of a sensor configured to detect human or pet occupancy; and
commanding a reduction in power of the directed energy beam based on the determination that a human or pet is in the vicinity of the directed energy beam.

20. The computer-readable medium of claim 15, wherein the directed energy recharger comprises a device selected from the group consisting of a lighting fixture, a mirrored ball, a robotic vacuum cleaner, a flying drone, a wall-mounted AC electrical outlet, a wall-mounted light switch, and a smart TV that comprises the at least one computing device.
